(19) United States
(12) Patent Application Publication
(10) Pub. No.: US 2024/0288637 A1
(43) Pub. Date: Aug. 29, 2024

(54) FIBER OPTIC SPLICE CLOSURES

(71) Applicant: Hubbell Incorporated, Shelton, CT (US)

(72) Inventors: Nnamdi Gabriel Okafor, Birmingham, AL (US); Adrian Beau Candelaria, Montevallo, AL (US); Rabih Miled Al Ghossein, Hoover, AL (US)

(21) Appl. No.: 18/588,872

(22) Filed: Feb. 27, 2024

Related U.S. Application Data
(60) Provisional application No. 63/448,900, filed on Feb. 28, 2023.

(51) Int. Cl. G02B 6/38; G02B 6/44

(52) U.S. Cl. CPC G02B 6/3855; G02B 6/44775

(57) ABSTRACT

A fiber optic cable closure assembly including an enclosure having an open end, an end plate assembly for sealing the open end, including at least one fiber optic cable receiving port including a first cable receiving port cartridge a portion of which is formed integral to the end plate assembly, a second cable receiving port cartridge pivotable with respect to the first cable receiving port cartridge between first and second positions and a latch member operably associated with the second cable receiving port cartridge for securing the first cable receiving port cartridge to the second cable receiving port cartridge. In the first position, the cartridges allow a cable to be positioned between the first and second cable receiving port cartridges. In the second position, cartridges form a sealing closure around the cable positioned between the first cable receiving port cartridge and the second cable receiving port cartridge.

### CROSS-REFERENCE TO RELATED APPLICATIONS

This application is based on and claims priority to U.S. Provisional Application Ser. No. 63/448,900 filed Feb. 28, 2023 entitled Fiber Optic Splice Closures the contents of which are incorporated herein in their entirety by reference.

### TECHNICAL FIELD

The present disclosure relates generally to splice closures. More specifically, the present disclosure relates to fiber optic splice closures.

### DESCRIPTION OF THE RELATED ART

As the need for greater bandwidth and faster data transfer rates for voice, video and data services has increased, the need for faster and faster communications has grown. Generally speaking, the speed of communication between any two or more points is limited by the slowest link Optical fibers allow the transfer of large amounts of data at almost the speed of light. Optical fibers are generally made from glass or plastic which may be roughly the diameter of a human hair. Fiber optic cables containing the optical fibers may be miles and miles long. Often, it is necessary to splice the optical fibers to add additional runs, add cable branches and to repair broken optical fibers.

While the fiber optic cables are generally tough and durable, the individual optical fibers are still fragile. When splicing optical fibers, care must be taken during the splicing process. After the splicing is complete, the splices must be protected from environmental factors. This can be difficult, particularly when the splices are in a noncontrolled environment where they could be subjected to large temperature fluctuations, water, snow, etc. Weatherproof splice enclosures exist for housing optical fiber splices in such noncontrolled environments. To ensure the splices are protected, these weatherproof enclosures are generally made airtight and watertight.

While existing weatherproof enclosures are suitable and provide excellent benefits protecting optical fiber splices, they often require tools such as wrenches, sockets, etc. to open and close the containers. A need exists for a splice enclosure that does not require such tools and allows the enclosure to be easily opened and closed while still providing an airtight and watertight space for the optical fiber splices. Furthermore, existing weatherproof enclosures are generally a “one size fits all” in that the enclosure is generally only capable of receiving fiber optic cables having a certain set diameter. A need exists for a waterproof splice enclosure that includes replaceable cartridges allowing the ports for receiving fiber optic cables to be readily modified and capable of receiving cables having various diameters. A replaceable cartridge also allows a damaged port to be easily replaced with a port capable of receiving a fiber optic cable having the same diameter.

### SUMMARY OF THE INVENTION

The present disclosure provides embodiments of fiber optic cable closure assemblies including an enclosure having an open end, an end plate assembly for sealing the open end, the end plate assembly including at least one fiber optic cable receiving port including a first cable receiving port cartridge at least a portion of which is formed integral to the end plate assembly, a second cable receiving port cartridge pivotable with respect to the first cable receiving port cartridge between at least first and second positions and a latch member operably associated with the second cable receiving port cartridge for selectively securing the first cable receiving port cartridge to the second cable receiving port cartridge. In the first position, the first and second cable receiving port cartridges allow a cable to be positioned between the first and second cable receiving port cartridges and in the second position, the first and second cable receiving port cartridges form a sealing closure around the cable positioned between the first cable receiving port cartridge and the second cable receiving port cartridge.

In another exemplary embodiment a fiber optic cable closure includes a first cable receiving port cartridge including a first pliable gel pad, at least a portion of the first cable receiving port cartridge being formed integral to the fiber optic cable closure and a second cable receiving port cartridge including a second pliable gel pad, the second cable receiving port cartridge movable with respect to the first cable receiving port cartridge between at least first and second positions. In the first position, the first and second cable receiving port cartridges allow a cable to be positioned between the first and second pliable gel pads and in the second position, the first and second pliable gel pads form a sealing closure around the cable.

### BRIEF DESCRIPTION OF THE DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a perspective view of a splice closure assembly according to an illustrative embodiment of the present disclosure;

FIG. 2 is an exploded view showing the contents of the splice closure assembly according to an illustrative embodiment of the present disclosure;

FIG. 3 is a side view of the splice closure assembly according to an illustrative embodiment of the present disclosure;

FIG. 4 is a cross-sectional view of the splice closure depicted in FIG. 3 taken along the lines 4-4, according to an illustrative embodiment of the present disclosure;

FIG. 5 is a perspective view of the enclosure assembly depicting the contents of the splice closure according to an illustrative embodiment of the present disclosure;

FIG. 6 is an exploded view of the enclosure assembly according to an illustrative embodiment of the present disclosure;

FIG. 7 is a cross-sectional view of the splice closure taken along the lines 7-7 in FIG. 3 according to an illustrative embodiment of the present disclosure;

FIG. 7A is an enlarged cross-sectional view showing the water tight and air tight closure according to an illustrative embodiment of the present disclosure;

FIG. 8 is an enlarged view of a portion of the end plate forming a portion of the enclosure assembly depicted in FIG. 6, according to an illustrative embodiment of the present disclosure;

FIG. 9 is an exploded view of the enclosure assembly according to an illustrative embodiment of the present disclosure;

FIG. 10 is an enlarged view of a portion of the enclosure assembly depicted in FIGS. 9, according to an illustrative embodiment of the present disclosure;

FIG. 11 is a cross-sectional view of a portion of the enclosure assembly depicted in FIG. 10 taken along the lines 11-11 according to an illustrative embodiment of the present disclosure;

FIGS. 11A is a rear perspective view of the portion of the enclosure assembly depicted in FIG. 10, according to an illustrative embodiment of the present disclosure;

FIG. 12 is a perspective view of a removable outer receiving port assembly according to an illustrative embodiment of the present disclosure;

FIG. 13 is a bottom view of the removable outer receiving port assembly according to an illustrative embodiment of the present disclosure;

FIG. 14 is a rear perspective view of the removable outer receiving port assembly according to an illustrative embodiment of the present disclosure;

FIG. 15 is a perspective view of a ratchet latch member according to an illustrative embodiment of the present disclosure;

FIG. 16 is a perspective view showing attachment of the ratchet latch member to the removable outer receiving port assembly according to an illustrative embodiment of the present disclosure;

FIG. 17 is a perspective view showing the ratchet latch member attached to the removable outer receiving port assembly according to an illustrative embodiment of the present disclosure;

FIG. 18 is a perspective view showing attachment of the removable outer receiving port assembly to the integral inner receiving port assembly with a fiber optical cable therebetween, according to an illustrative embodiment of the present disclosure;

FIG. 19 is a perspective view showing attachment of the removable outer receiving port assembly to the integral inner receiving port assembly with a fiber optical cable therebetween, according to an illustrative embodiment of the present disclosure;

FIG. 20 is a perspective view showing the removable outer receiving port assembly joined to the integral inner receiving port assembly with a fiber optical cable therebetween, according to an illustrative embodiment of the present disclosure;

FIG. 21 is a rear view of the removable receiving port assembly joined to the integral inner receiving port assembly with a fiber optical cable therebetween, according to an illustrative embodiment of the present disclosure;

FIG. 22 is a perspective view of an optical fiber splice tray according to an illustrative embodiment of the present disclosure;

FIG. 23 is a perspective view of a base portion of the optical fiber splice tray according to an illustrative embodiment of the present disclosure;

FIG. 24 is a perspective view of a cover portion of the optical fiber splice tray according to an illustrative embodiment of the present disclosure;

FIG. 25 is a side view of the optical fiber splice tray being attached to a riser according to an illustrative embodiment of the present disclosure;

FIGS. 26A and 26B perspective front and rear views of an end plate assembly according to another illustrative embodiment of the present disclosure;

FIG. 27 is a front view of an end plate assembly depicting components forming cable receiving ports according to an illustrative embodiment of the present disclosure;

FIG. 28 is an exploded view of an inner gel pad assembly according to an illustrative embodiment of the present disclosure;

FIG. 29 is an assembled view of the inner gel pad assembly according to an illustrative embodiment of the present disclosure;

FIG. 30 is an enlarged perspective front view of an inner receiving port assembly according to an illustrative embodiment of the present disclosure;

FIG. 31 is an enlarged perspective rear view of an inner receiving port assembly according to an illustrative embodiment of the present disclosure;

FIG. 32 is an exploded view of a removable outer receiving port assembly cartridge according to an illustrative embodiment of the present disclosure;

FIG. 33 is an upper perspective view of a main body of the removable outer receiving port assembly cartridge of FIG. 32 according to an illustrative embodiment of the present disclosure;

FIG. 34 is a lower perspective view of the main body of the removable outer receiving port assembly cartridge of FIG. 33 according to an illustrative embodiment of the present disclosure;

FIG. 35 is a perspective rear view of a compression member forming a portion of the removable outer receiving port assembly cartridge of FIG. 32 according to an illustrative embodiment of the present disclosure;

FIG. 36 is a rear perspective view of a gel pad member forming a portion of the removable outer receiving port assembly cartridge of FIG. 32 according to an illustrative embodiment of the present disclosure;

FIG. 37 is a front perspective view of the gel pad member forming a portion of the removable outer receiving port assembly cartridge of FIG. 32 according to an illustrative embodiment of the present disclosure;

FIG. 38 is a partial exploded view of the removable outer receiving port assembly cartridge of FIG. 32 showing components forming a locking mechanism for locking the removable outer receiving port assembly cartridge in the end plate assembly according to an illustrative embodiment of the present disclosure;

FIGS. 39A-39C are views for describing operation of the locking mechanism depicted in FIG. 38 according to an illustrative embodiment of the present disclosure;

FIG. 40 is a perspective view of the removable outer receiving port assembly cartridge in an uncompressed state according to an illustrative embodiment of the present disclosure;

FIG. 41 is a perspective view of the removable outer receiving port assembly cartridge in a compressed state according to an illustrative embodiment of the present disclosure;

FIG. 42 is a cross-sectional view taken along lines 42-42 of FIG. 41 showing expansion of the gel pad member when in the compressed state according to an illustrative embodiment of the present disclosure;

FIGS. 43A, 43B are views of a locking collar according to an illustrative embodiment of the present disclosure;

FIG. 44 is a perspective view of a strength member for securing a fiber optic cable according to an illustrative embodiment of the present disclosure;

FIG. 45 is a perspective view of a fiber optic splice tray according to an illustrative embodiment of the present disclosure;

FIG. 46 is a rear perspective view of fiber optic splice trays connected to a riser according to an illustrative embodiment of the present disclosure; and

FIG. 47 is a front perspective view of fiber optic splice trays connected to a riser according to an illustrative embodiment of the present disclosure.

### DETAILED DESCRIPTION

The present disclosure provides embodiments of a closure assembly for containing spliced optical fibers in a sealed, waterproof and airtight space. The closure assembly is capable of receiving a plurality of fiber optic cables, each having one or more and, in most instances, many individual optical fibers. Various types of fiber optic cables exist and the closure assembly according to illustrative embodiments of the present disclosure is not limited to any particular type of fiber optic cable. It will be appreciated from the present disclosure that aspects of the mechanism for holding the fiber optic cable within the closure assembly may vary depending on the type of fiber optic cable and, more specifically, the type or types of strength members associated with the particular fiber optic cable. Strength members are often used within fiber optic cables to give the cable some added rigidity and may be formed, for example, from one or more fiberglass or metal rods. The individual fiber optic strands within the fiber optic cable are generally housed in buffer tubes which provide several benefits including, for example, mechanical isolation, protection from physical damage and fiber identification.

The components forming the port or ports allowing the fiber optic cable to pass through into the enclosure assembly may be in the form of more or more removable cartridges, thus allowing the dimensions of the port or ports of the closure assembly to be readily modifiable to receive fiber optic cables of various dimensions or diameter. The removable cartridges are removable from a portion of the closure assembly housing and may include locking mechanisms for locking the removable cartridge to the housing. The removable cartridge or cartridges form an airtight and watertight seal around the fiber optic cable. A closure assembly according to illustrative embodiments of the present disclosure is capable of simultaneously receiving one or more different types of fiber optic cables, forming an airtight, watertight seal around each of the fiber optic cables. The distal end of the fiber optic cables to be contained within the closure assembly may have one or more outer protective layers stripped back allowing access to the individual optical fibers or strands. The individual optical fibers may be spliced utilizing any known method including, for example, fusion or mechanical connectors. The splices may then be neatly organized in any one of a plurality of splice trays which may be neatly arranged in a stacked arrangement within the closure assembly. For ease of description, the spliced connection whether by fusion or mechanical connectors, may be referred to generally as the “splice” in the singular and the “splices” in the plural. The main fiber optic cable holding the plurality of individual fiber optic fibers or strands may be referred to as the “fiber optic cable” or “cable” in the singular and the “fiber optic cables” or “cables” in the plural. The individual optical fibers or fiber optic strands may also be referred to generally as “fiber optic cable” or the “fiber” or “strand” in the singular and as the “fiber optic cables” or the “fibers” or “strands” in the plural. Illustrative embodiments of the present disclosure refer to the terms “gel” or “gel pads”. These terms may encompass any of a number of semirigid materials that are substantially pliable or flexible and capable of being compressed and assuming the compressed shape.

The present disclosure also provides embodiments of splice trays configured to hold spliced fibers in a neat and efficient manner. A plurality of splice trays may be provided and arranged in a stacked configuration while allowing easy access to any of the splice trays in the stack. The splice trays may include a bottom portion upon which the optical fibers and splices may be arranged and a removable cover for covering the bottom portion containing the splices. The removable cover may be capable of pivoting open on the bottom portion to an open position while allowing the cover to be easily removed from the bottom portion as desired.

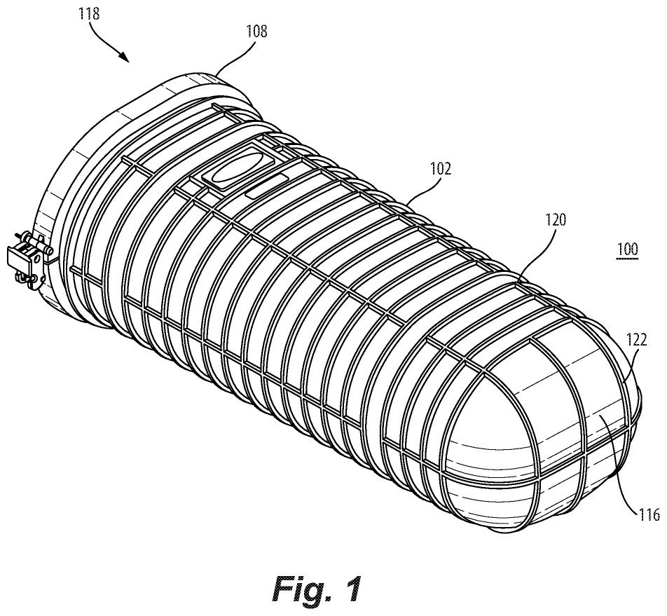

A splice closure assembly according to an illustrative embodiment of the present disclosure is shown in FIG. 1 and may be referred to as assembly 100. Assembly 100 includes an enclosure or closure 102. According to an embodiment of the present disclosure, enclosure 102 can be sealed to help keep out moisture and/or other contaminants which could be harmful to the contents of the enclosure. An air valve (not shown) may be provided allowing the enclosure 102 to be pressurized for flash testing purposes. Enclosure 102 may be formed from any suitable type of material which is strong, water-impermeable, non-biodegradable, durable and rigid. Non-limiting examples of suitable types of materials include high impact resistant plastics. Materials including polyvinyl chloride (PVC) and/or polycarbonate may be used as well as polypropolyne alone or in combination with one or more strengthening material(s) such as additive-filled polypropylene may be suitably used to form various aspects of the present disclosure. Suitable strengthening materials may include fiberglass, carbon fibers, etc.

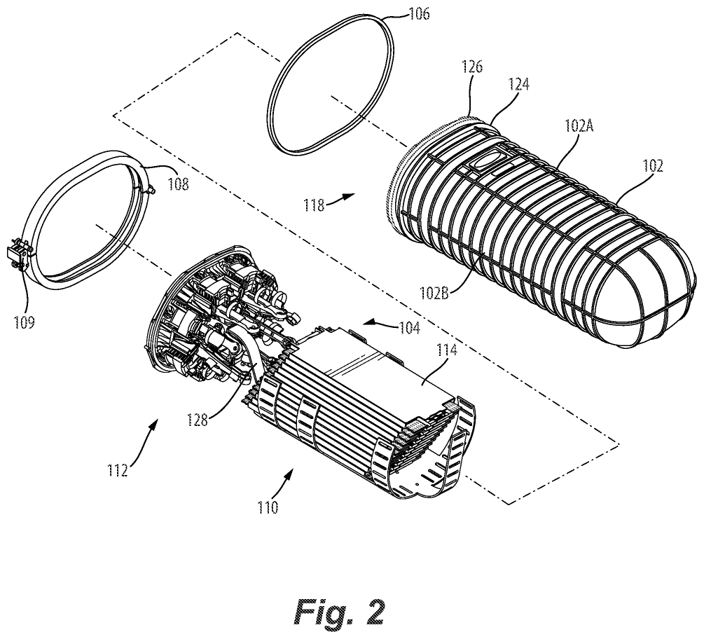

Enclosure 102 may include a plurality of encompassing and longitudinal ribs 120, 122 extending around the periphery providing added strength and rigidity to the enclosure 102. The enclosure 102 includes a first end 116 and a second end 118. First end 116 of enclosure 102 is closed as shown. Second end 118 of enclosure 102 is generally open but may be sealed by an end plate assembly 112, gasket 106 and sealing collar 108 depicted in FIGS. 2 and 2A. Sealing collar 108 includes a clamping mechanism 109. According to this illustrative embodiment of the present disclosure and as will be described in further detail below, end plate assembly 112 includes at least one cable receiving port which is capable of receiving a main fiber optic cable. In the illustrative embodiment described herein, eight (8) such cable receiving ports are provided in end plate assembly 112 so that up to eight (8) fiber optic cables can be received in splice closure assembly 100. Each fiber optic cable may include a plurality of fiber optic strands. Each cable receiving port forms an airtight, watertight seal around the fiber optic cable.

End plate assembly 112 forms a part of an enclosure assembly 104 which also includes a splice tray holding assembly 110 used for holding one or more splice trays 114, each capable of holding one or more fiber optic splices as well as optical fiber slack in a neat, efficient and protective manner. According to an illustrative embodiment of the present disclosure described below, splice tray holding assembly 110 is designed to removably hold up to twelve (12) splice trays 114. Of course, splice tray holding assembly 110 may be readily designed to hold any desired number of splice trays 114. Splice tray holding assembly 110 is attached to end plate assembly 112 by S-shaped arm member 128. A pair of flanges 124, 126 are provided around the periphery of enclosure 102 at second end 118. Flanges 124, 126 provide added rigidity and support to the opening formed at second end 118. As will be described later below, flange 126 forms part of a sealing enclosure for sealing second end 118 of enclosure 102 utilizing end plate assembly 112, gasket 106 and sealing collar 108. As depicted in FIGS. 1 and 2, enclosure 102 is generally oblong in cross-section. The sides 102A, 102B of enclosure 102 may taper slightly from second end 118 toward first end 116.

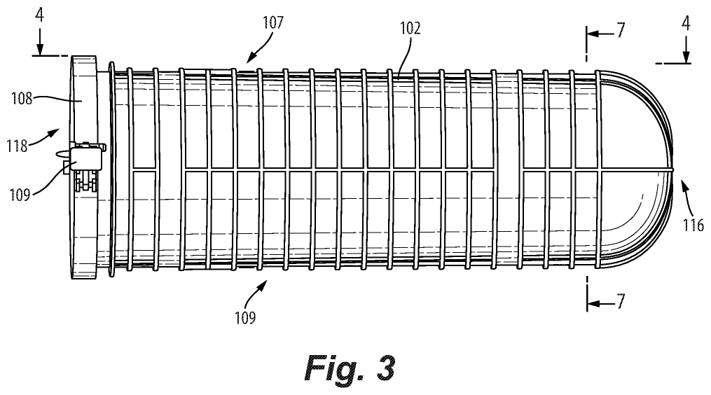

As shown in FIG. 3, the top 107 and bottom 109 surfaces of enclosure 102 are generally straight and may taper slightly from second end 118 toward first end 116. It will be appreciated the top 107 and/or bottom 109 surfaces of enclosure 102 may include a slight outward curvature or preferably a slight inward curvature forming a preloaded structure to compensate for any outward bending force that may occur when the enclosure 102 is pressurized.

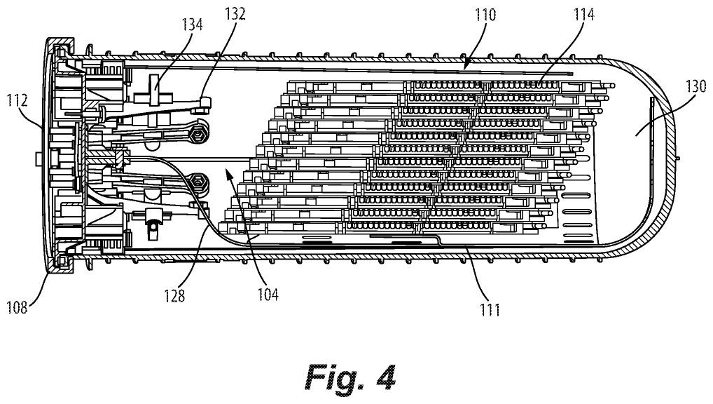

As shown in cross-section in FIG. 4, the enclosure assembly 104 fits neatly within and extends substantially the entire length of enclosure 102. The lower plate 111 of tray holding assembly 110 extends from and is supported by end plate assembly 112 via inverted generally “S-shaped” arm member 128. Lower plate 111 may rest on the lower inside surface of enclosure 102 or S-shaped arm member 128 may keep lower plate 111 in position just above the bottom surface of enclosure 102. A plurality of strength members 132 extend inward from end plate assembly 112 into the gap formed between end plate assembly 112 and tray holding assembly 110. According to the present illustrative embodiment of the present disclosure, eight (8) strength members 132 are provided, one for each of the fiber optic cable receiving ports. Each strength member 132 may include a clamp member 134 used to secure a one or more strength member cables within the fiber optic cable which will be described in more detail below.

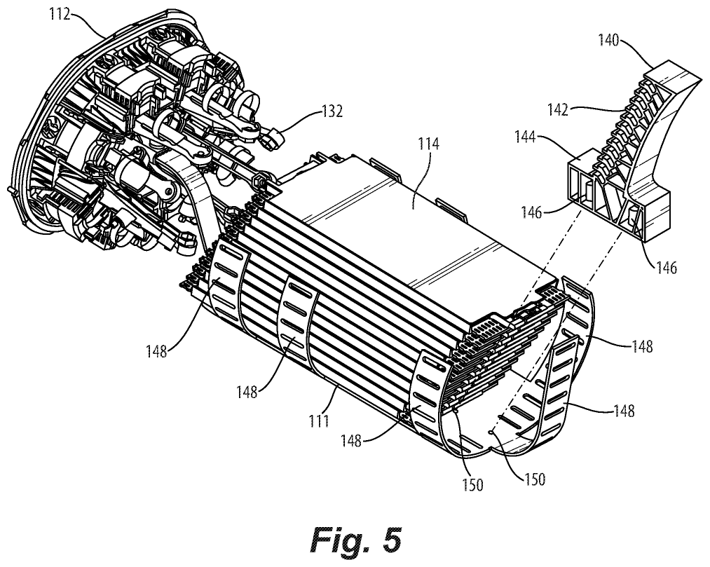

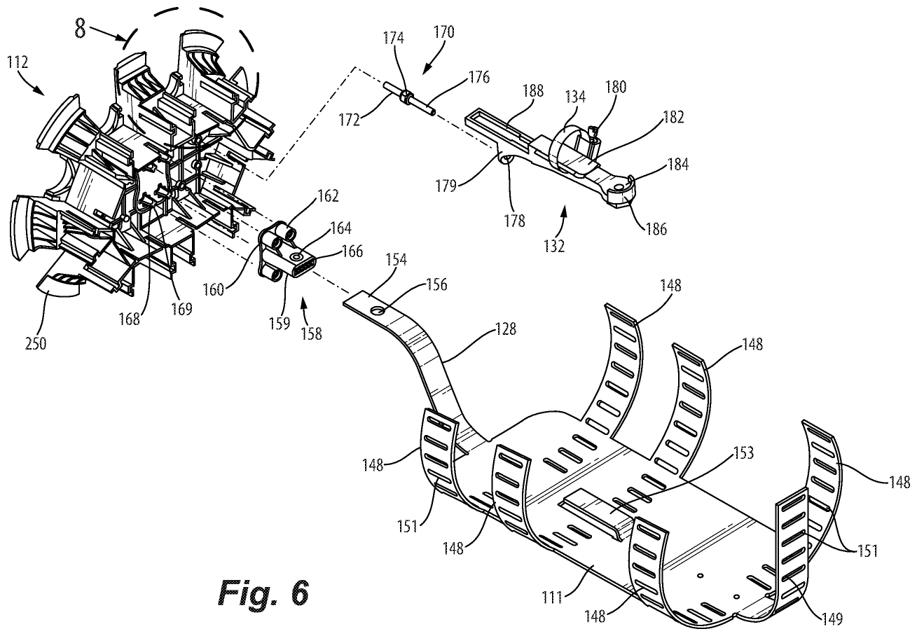

Although not shown in FIG. 4, for reasons of clarity, a tray holding riser member 140 as depicted in FIG. 5, supports and holds trays 114 in a stacked arrangement. Tray holding riser member 140 is attached to lower plate 111 using the one or more attachment points 150 provided in lower plate 111. According to the present illustrative embodiment, attachment points 150 are holes provided in lower plate 111 which allow screws (not shown) to be passed up through the bottom of lower plate 111 and received and screwed into corresponding threaded portions 146 of member 140. Of course, it will be appreciated tray holding riser member 140 may be attached to lower plate 111 using any suitable manner of connection including, for example, welding, riveting, adhesive, etc. Tray holding riser member 140 includes a series of notches 142 into which an end portion of each of splice trays 114 is designed to fit, as will be described in more detail later below, so that a neat stack of splice trays 114 are formed. Tray holding riser member 140 includes a ledge or lip 144 and lower plate 111 includes a raised standoff 153 (e.g., see FIG. 6) upon which the lowest of the splice trays 114 in the stack of splice trays may rest.

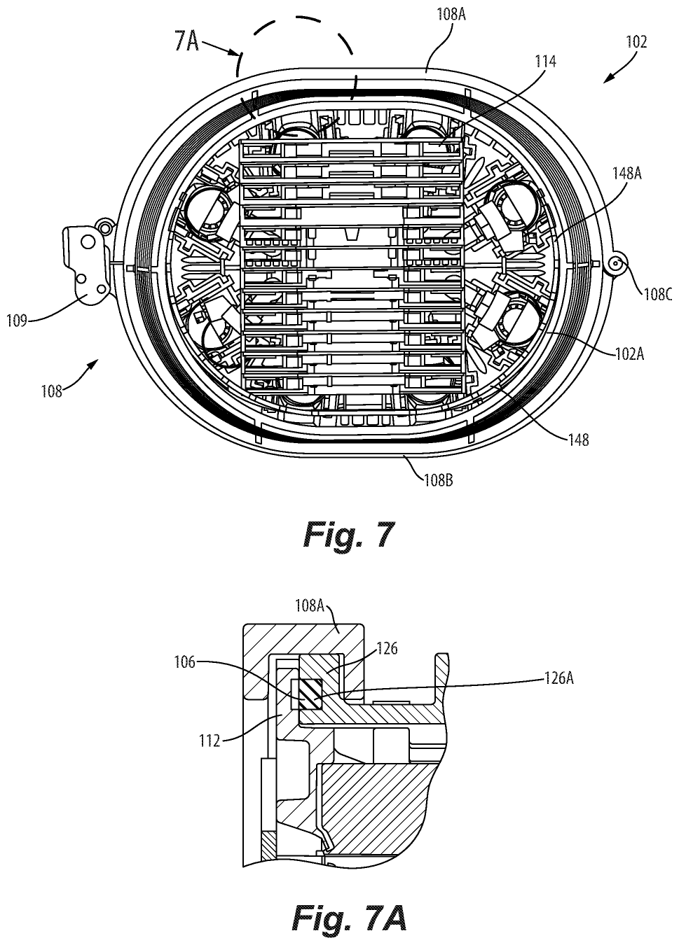

As depicted in FIGS. 6 and 7, tray holding assembly 110 includes one or more and in this exemplary embodiment, six (6) arcuate strap members 148 extending from the outside edges of the lower plate 111. According to an embodiment of the present disclosure, each arcuate strap member 148 has a longitudinal cross-section substantially similar to a cross-section of the adjacent side portions 102A of enclosure 102. The distal end portions 148A of each strap member 148 may extend slightly outward as shown in FIG. 7 and may make contact with the inside surface of side portions 102A of enclosure 102, providing support and limiting movement of lower plate 111 and trays 114. Of course, it will be appreciated each arcuate strap member 140 may have different longitidunal cross-sections from the side portions of enclosure 102 and/or each other, as long as each arcuate strap member 148 is dimensioned and shaped so as not to extend beyond a profile that would hinder tray holding assembly 110 being easily slid into enclosure 102. At least one rear strap member 149 may be provided extending from the rear portion of lower plate 111 to be positioned closest to the first surface 116 of enclosure 102. As shown, rear strap member 149 extends arcuately from lower plate 111 to a straight portion, substantially matching the adjacent inside surface of the rear or first end 116 of enclosure 102. It will be appreciated rear strap member 149 may be designed to extend differently so along as rear strap member 140 does not interfere with tray holding assembly 110 being easily slid into enclosure 102. Each strap member 148, 149 includes one or more holes or slots 151 extending therethrough. Straps (not shown) may be attached between members 148, 149 as desired using holes or slots 151 to further secure trays 114 in position.

As depicted in FIGS. 7 and 7A, sealing collar 108 includes a generally U-shaped first portion 108A and a generally U-shaped second portion 108B joined at their distal ends by hinge member 108C. First and second portions 108A and 108B are generally U-shaped in cross-section. A clamping mechanism 109 is provided for removably joining the first portion 108A and the second portion 108B at their proximal ends. A non-limiting example of a clamping mechanism may include a draw type clamping mechanism. As shown in the enlarged cross-sectional view 7A, a groove 126A is provided around the front face surface of flange 126 of enclosure 102. Groove 126A is dimensioned to receive sealing gasket 106 which abuts a rear surface of end plate assembly 112. As the clamping mechanism 109 is drawn tight, enclosure 102 is sealed providing an air tight and water tight seal.

As shown in FIG. 6, inverted “S-shaped” arm member 128 extending from lower plate 111 is connected to end plate assembly 112 via a platform bracket 158. Platform bracket 158 includes a plurality of recessed receivers 162 extending from the rear plate 160 of platform bracket 158 for receiving corresponding standoffs 168 extending from the inner surface of end plate 250 of end plate assembly 112. Each standoff 168 may include a threaded bore 169 extending longitudinally at least partially therethrough. Platform bracket 158 may be attached to plate 250 using screws (not shown) extending through receivers 162 and into the threaded bores provided in the ends of standoffs 168. A projection 159 extends at a substantially right angle from rear plate 160 of bracket 158 and includes a slotted hole 166 extending through at least a portion thereof. Slotted hole 166 is dimensioned to receive a distal end portion 154 of “S-shaped” arm member 128. Projection 159 includes a hole 164 extending transversely therethrough positioned and dimensioned to correspond to hole 156 extending transversely through the distal end portion of “S-shaped” arm member 128. A clevis bolt and cotter pin (not shown) may be used to attach S-shaped member 128 to platform bracket 158 utilizing holes 164, 156.

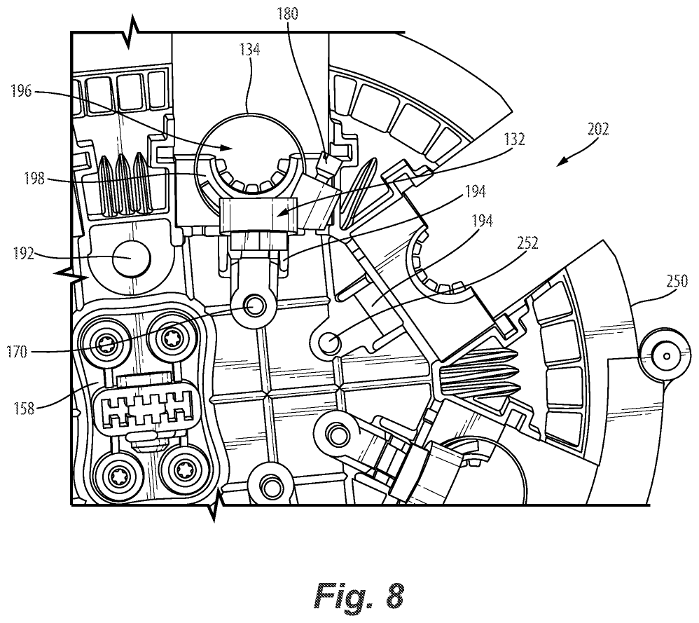

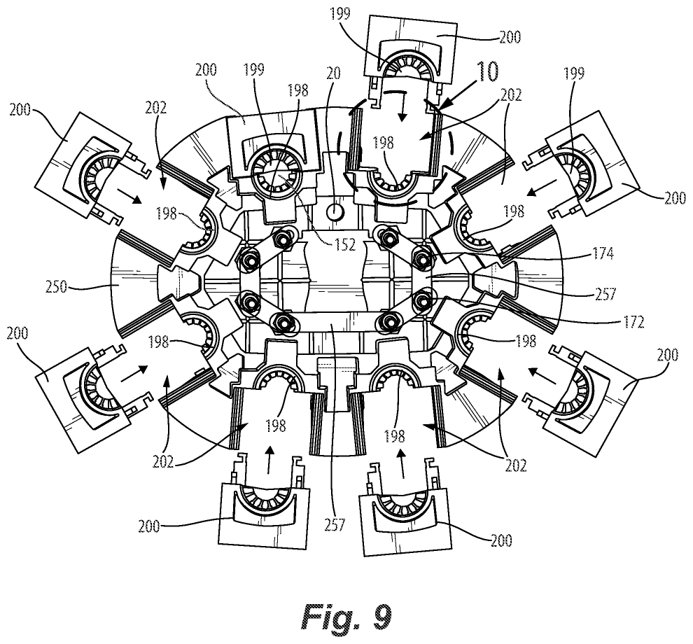

Although only one is shown in FIG. 6 for purposes of clarity, a plurality of threaded ground rod assemblies 170 and corresponding strength members 132 may be provided. More specifically, a threaded ground rod assembly 170 and corresponding strength member 132 are provided for each of the corresponding eight (8) cable receiving ports and used to support and secure the fiber optic cable. A distal end 172 of threaded ground rod assembly 170 passes through orifice 252 which extends through end plate 250 (e.g., see FIG. 8). As further shown in FIGS. 9, 9A, the distal ends 172 of each ground rod assembly 170 extend through to the front face of end plate 250. The distal ends 172 of one or more of the ground rods 170 may be interconnected. For example, as shown in FIG. 9, one or more electrically conductive plates 257 may be provided for electrically interconnecting two or more and in this exemplary embodiment, each of the eight (8) ground rod assemblies 170 passing through end plate 250. Nuts 174 may be attached to threaded distal ends 172 of ground rod assemblies 170 securing ground rod assemblies 170 and plates 257 to end plate 250. A hole 20 may be provided in end plate 250 for receiving an air valve (not shown) allowing the enclosure 102 to be pressurized with air and flash tested after the enclosure has been sealed.

Returning to FIG. 6, the proximate end 176 of threaded ground rod assembly 170 extends inward from end plate 250 and passes through hole 178 in support arm 179 extending from strength member 132. A nut 174 may then be used to secure the proximate end 176 of threaded ground rod assembly 170 to support arm 179 so that strength members 132 are generally positioned and extend generally at right angles to end plate 250 and are positioned below the corresponding cable receiving port area 196 (e.g., see FIG. 8). As shown in FIG. 6, each strength member 132 includes a substantially flat proximate end 188 which is received in a corresponding notch 194 formed in the rear surface of plate 250 (e.g., see FIG. 8) adjacent orifice 252 through which the distal end 172 of threaded ground rod 170 extends. Flat proximate end 188 of strength member 132 extends to arcuate plate 182 upon which a fiber optic cable will rest on and be clamped to by clamp 134 using screw member 180. Clamp 134 and screw member 180 may be a hose clamp where a portion of the screw member 180 (e.g., the worm gear portion) is integrated into the strength member 132 or may be a separate removable hose clamp used to clamp the fiber optic cable to strength member 132. The distal end 186 of strength member 132 includes an orifice 184 capable of receiving a bolt and washer used to attach a strength member cable provided in the fiber optic cable to strength member 132. Orifice 184 may be threaded to receive a correspondingly threaded bolt (not shown). Alternatively, the underside of strength member 132 below orifice 184 may include an integrated nut receptacle 186 for receiving a nut which engages a bolt which extends through orifice 184. The nut receptacle 186 allows the bolt extending through orifice 184 to be tightened without the need of applying a separate wrench to the nut when tightening the bolt.

As depicted in FIG. 9, end plate 250 is generally oblong in shape but may have a different shape such as, for example, oval, elliptical or the like. End plate 250 has a plurality of cable receiving ports 152 each capable of receiving a main fiber optic cable. In this illustrative embodiment, eight (8) such cable receiving port areas are provided so that up to eight (8) main fiber optic cables can be received in splice closure assembly 100. Of course, the design and dimensions of end plate 250 can be modified to provide more or fewer cable receiving ports as desired. Each cable receiving port 152 is formed by an integral inner receiving port assembly 202 and a removable outer receiving port assembly or cartridge 200 which is received in and sealingly mates with the integral inner receiving port assembly 202. As will be described later below, the integral inner receiving port assembly 202 includes a removable and replaceable gel pad member or cartridge 198. Each cable receiving port 152 is capable of receiving and holding a main fiber optic cable and providing a watertight and airtight seal around the main fiber optic cable. For example, each integral inner receiving port assembly 202 holds a first gel member 198 and each removable outer receiving port assembly or cartridge 200 holds a second gel member 199. When a main fiber optic cable is placed between the inner receiving port assembly 202 and the outer receiving port assembly 200 and the outer receiving port assembly or cartridge 200 is locked in place creating cable receiving port 152, the first and second gel members 198, 199, form a watertight and airtight seal around the main fiber optic cable.

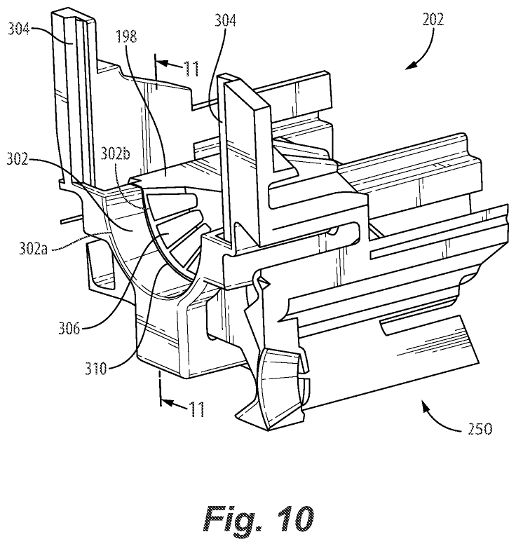

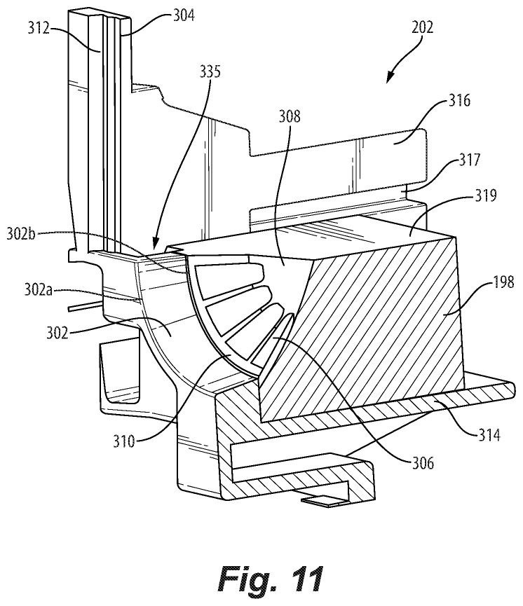

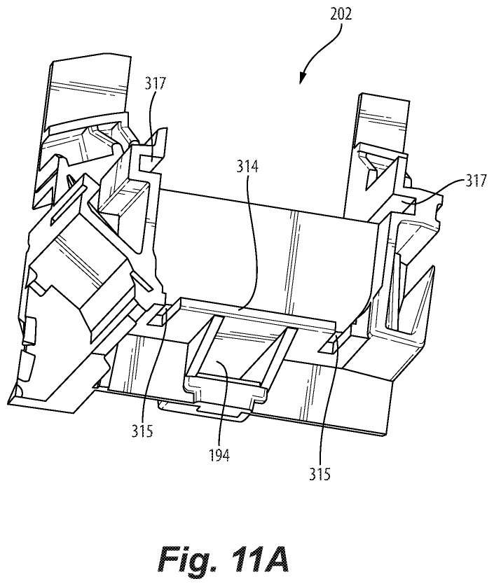

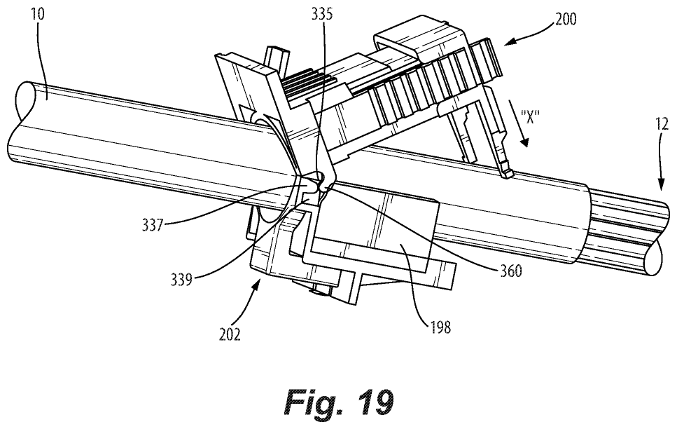

As shown in FIGS. 10 and 11, the integral inner receiving port assembly 202 includes a semi-circular opening surface 302 and side uprights 304. The semi-circular opening surface 302 may have a diameter generally the same or slightly larger than a diameter of the fiber optic cable to be received in the cable receiving port and may be tapered. For example, the diameter of the outer edge 302a of surface 302 may be larger than the inner edge 302b of surface 302. One or more flexible teeth or prongs 306 extend from the upper inner edge 302b of semi-circular opening surface 302 and abut gel member 198. First gel member 198 is generally rectangular in shape and is dimensioned to fit snugly within the side walls 316 of the integral inner receiving port assembly 202 and rests on platform 314 which extends from the inside surface of end plate 250 (e.g., see FIG. 11). A longitudinal half conical shaped portion of gel member 198 adjacent semi-circular opening surface 302 is missing or removed from the top 319 of gel member 198, forming a half conical shaped surface 308. Flexible teeth or prongs 306 are shaped and dimensioned so that they are adjacent to and may rest on the conical shaped surface 308 and may even extend through a portion 310 of the gel member 198 as shown. Alternatively, some or all of the teeth or prongs 306 may be completely embedded within gel member 198. Side uprights 304 include a raised lip 312 which mates with corresponding grooves in portions of the removable outer receiving port assembly 200 providing a watertight and airtight seal as will be described in more detail later below. Grooves 317 are provided in side walls 316 and extend generally parallel to an upper surface 319 of gel member 198 as shown (see also FIG. 11A). Slots 335 are provided on each side of opening surface 302 and, as will be described later below, include a hook like member (e.g., see FIG. 19, hook like member 337) used for attaching removable outer receiving port assembly 200 to the integral inner receiving port assembly 202. As shown in FIG. 11A, the rear portion of the integral inner receiving port assembly 202 includes slots 315 in either side of platform 314.

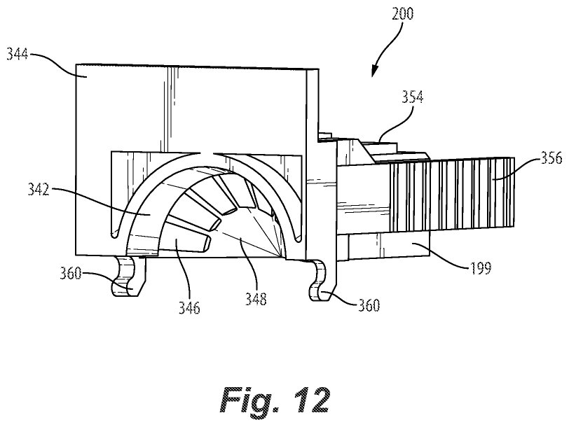

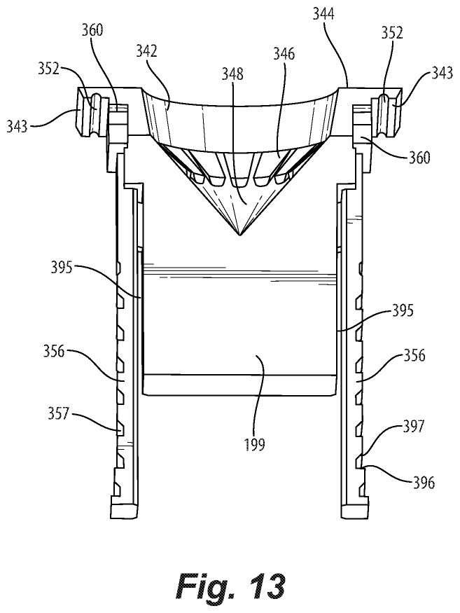

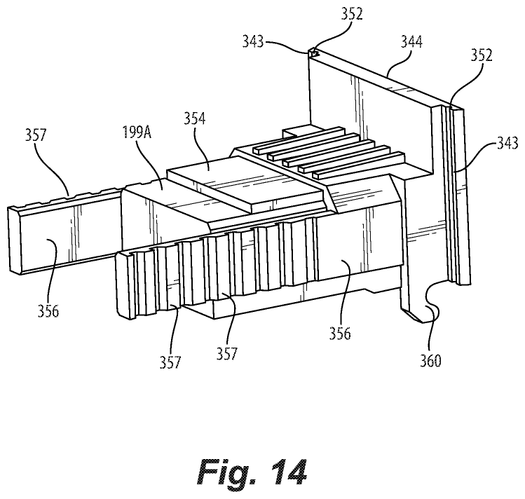

A removable outer receiving port assembly 202 is shown in FIGS. 12-14 and includes a semi-circular opening surface 342 and a front wall 344. The semi-circular opening surface 342 may have a diameter generally the same as the diameter of the semi-circular opening surface 302 provided in integral inner receiving port assembly 202. That is, the semi-circular opening surface 342 may be the same or slightly larger than a diameter of the fiber optic cable to be received in the cable receiving port. One or more flexible teeth or prongs 346 extend down and inward from the upper inner edge of semi-circular opening surface 342. Second gel member 199 is generally rectangular in shape and a portion of the upper side 199A abuts an inside surface of upper wall 354 which extends from the inside surface of front wall 344 (FIG. 14). As depicted in FIG. 13, a gap 395 is provided between a portion of gel member 199 and the inside portions of arms 356. A longitudinal half conical shaped portion of gel member 199 adjacent opening surface 342 is missing or removed, forming a half conical shaped surface 348 (e.g., see FIGS. 13, 13A). Flexible teeth or prongs 346 are shaped and dimensioned so that they are adjacent to and may rest on the conical shaped surface 348 and may even extend through a portion of the gel member 199 similar to that described above with respect to first gel member 198. Similar to that described above with respect to the integral inner receiving port assembly 202, some or all of the teeth or prongs 346 may be completely embedded within gel member 199. The rear edge portions 343 of front wall 344 include vertical recesses or grooves 352 which mate with the corresponding raised lips 312 provided in the uprights 304 of the integral inner receiving port assembly 202 (e.g., see FIG. 11) providing a watertight and airtight seal. Arms 356 extend substantially perpendicular to front wall 344 and include a plurality of ratchet grooves 357. As depicted in FIG. 13, each ratchet groove 357 is defined by a first edge 396 which is substantially perpendicular to arm 356 and second edge 397 which extends at an angle from arm 356. The ratchet grooves 357 act as a portion of a rachet mechanism as will be described later below. Hooks 360 project downwardly on each side of front wall 344 as best shown in FIGS. 12 and 14. Hooks 360 removably mate with corresponding hook like members 337 (e.g., see FIG. 19) in slots 335 provided on each side of opening surface 302 along side walls 316, as will be described in further detail later below.

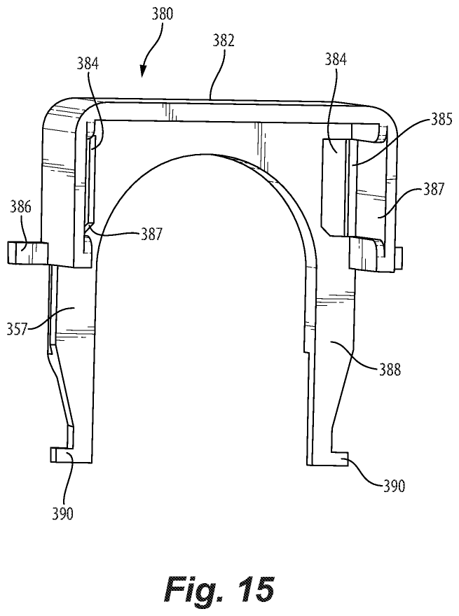

According to an illustrative embodiment of the present disclosure, a ratchet latch member 380 depicted in FIG. 15 is used to secure the removable outer receiving port assembly 200 to the integral inner receiving port assembly 202. Ratchet latch member 380 includes a main body 382 having inside tracks 387 which extend to slot like receiving ports 384. A ratchet tooth 385 extends partially into each receiving port 384 (only one shown). Inside tracks 387 and slot like receiving ports 384 are positioned and dimensioned for receiving arms 356 extending from removable outer receiving port assembly 200. Extension arms 388 extend downward from main body 382 and include outwardly extending hook members 390. Track arms 386 project outward substantially perpendicularly to the lower portion of main body 382.

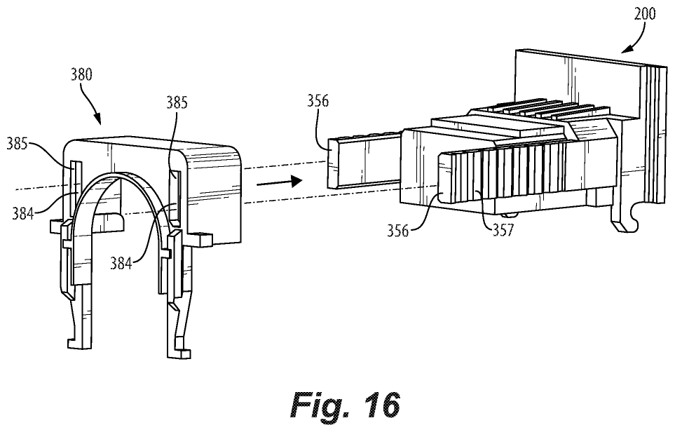

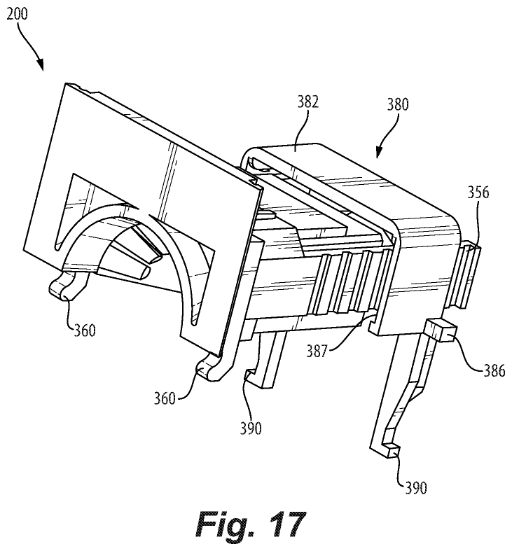

As depicted in FIGS. 16 and 17, arms 356 extending from removable outer receiving port assembly 200 extend through and are slidably received in inside tracks 387 and slot like receiving ports 384 in ratchet latch member 380. The ratchet teeth 385 extending into receiving ports 384 of ratchet latch member 380 engage ratchet grooves 357 in arms 356 of removable outer receiving port assembly 200 such that ratchet latch member 380 is free to ratchet and slide onto removable outer receiving port assembly 200 in the direction of the arrow depicted in FIG. 16. To disengage and remove the ratchet latch member 380 from the removable outer receiving port assembly 200, arms 356 are squeezed inward toward each other disengaging the ratchet teeth 385 from the ratchet grooves 357 allowing the ratchet latch member 380 to be easily slid in a direction opposite to the shown arrow.

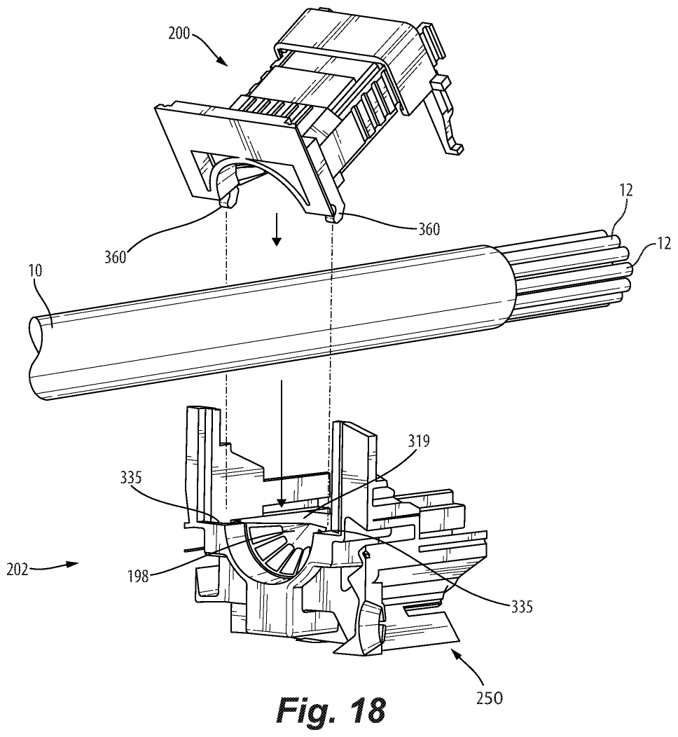

Referring to FIG. 18, a portion of the outer jacket and any other outer layers of the main fiber optic cable 10 including any outer strength member, inner cable jacket, etc. may be stripped away to expose individual optical fibers 12 or the buffer tubes containing the individual optical fibers 12. The jacketed portion of cable 10 is then positioned on the upper surface 319 of gel pad 198 in the integral inner receiving port assembly 202 of end plate 250. Hooks 360 projecting down from upper outer receiving port assembly 200 are then aligned with the corresponding slots 335 in integral inner receiving port assembly 202 while holding the outer receiving port assembly 200 at an angle of approximately 20-45 degrees with respect to the integral inner receiving port assembly 202. The outer receiving port assembly 200 is lowered onto the integral inner receiving port assembly 202 until the hooks 360 projecting down from outer receiving port assembly 200 enter the slots 335 and engage the hook like members 337 in integral inner receiving port assembly 202 as shown in cross-section in FIG. 19. The upper outer receiving port assembly 200 is then rotated in direction “X” until hooks 360 are fully seated in notches 339 below hook like member 337. A sufficient length of jacketed main fiber optic cable 10 should be left on the main fiber optic cable 10 so that the jacketed portion can rest on and be clamped to strength member 132 utilising clamp 134.

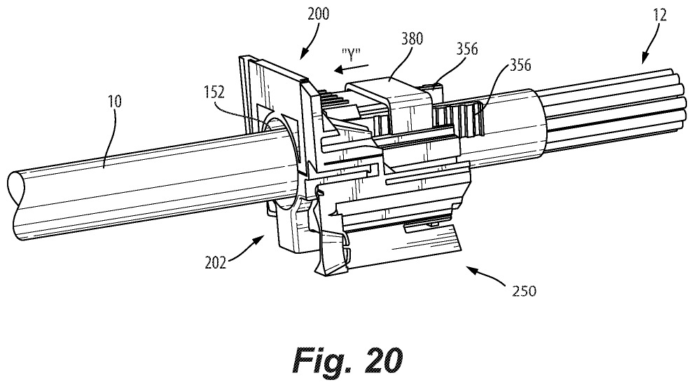

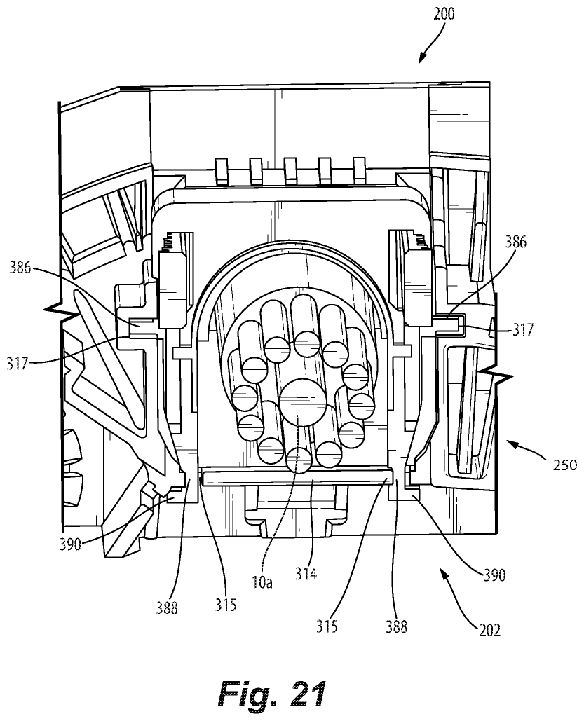

Referring to FIGS. 20 and 21, ratchet latch member 380 is then slid in direction “Y”. Track arms 386 extending from main body 382 of ratchet latch member 380 are received in grooves 317 provided in side walls 316 of integral inner receiving port assembly 202. In addition, hook members 390 extending from extension arms 388 of ratchet latch member 380 are received in slots 315 provided in lower plate 314 of the integral inner receiving port assembly 202 effectively securing the outer receiving port assembly 200 to the integral inner receiving port assembly 202 and forming cable receiving port 152. To release and remove the upper outer receiving port assembly 200, arms 356 are squeezed toward each other, releasing the ratchet mechanism and allowing ratchet latch member 380 to be slid in a direction opposite to direction “Y” (e.g., in the “−Y” direction) until track arms 386 are no longer within grooves 317 and hook members 390 are no longer received in slots 315. The upper outer receiving port assembly can then be rotated up and away from the integral inner receiving port assembly 200 so that cable 10 can be removed.

The teeth 306 and 346 (FIGS. 11, 12) extending from the outer receiving port assembly 200 and the integral inner receiving assembly 202 , respectively, maintain cable 10 generally centered in the cable receiving port 152 between the lower gel pad 198 provided in the integral inner receiving port assembly 202 and upper gel pad 199 provided in the outer receiving port assembly 200. Fiber optic cable 10 will also rest on and be clamped to arcuate plate 182 of strength member 132 by clamp 134 and screw member 180 (e.g., see FIGS. 6, 6A and 8, 8A), further maintaining cable 10 generally centered in the cable receiving port 152 between the upper gel pad 199 provided in the outer receiving port assembly or cartridge 200 and the lower gel pad 198 provided in the integral inner receiving port assembly 202. A main fiber optic cable 10 may include a strength member component 10a which extends generally in the middle portion of the cable surrounded by the individual fibers or bundles of individual fibers. Fiber optic cables may contain hundreds or even thousands of individual fibers. The strength member component 10a generally adds a degree of rigidity to the cable and allows the cable to be secured to a structure relieving stress on the individual fibers. According to the present embodiment, the strength member component 10a may be secured to strength member 132 utilizing a bolt (not shown) extending through orifice 184 in strength member 132 and secured with a nut (not shown).

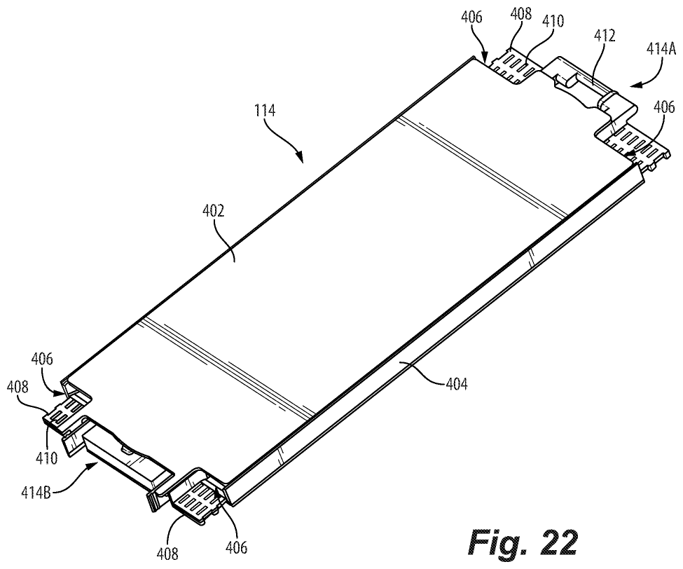

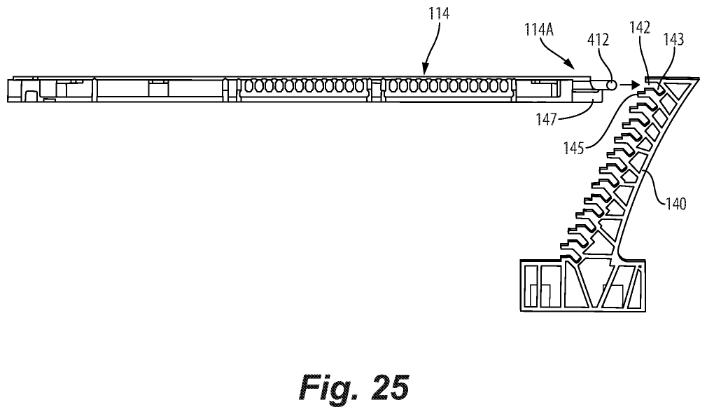

A fiber optic splice tray 114 according to an illustrative embodiment of the present disclosure is shown in FIG. 22 and may be referred to simply as tray 114. Tray 114 includes a base 404 and a cover 402. One or more optical fiber openings may be provided allowing optical fibers to be routed in and out of the fiber optic splice tray 114. According to the present illustrative embodiment, four optical fiber openings 406 are provided, one at each corner of the tray 114. Adjacent each optical fiber opening 406 is a tiedown platform 408 which extends from the base 404. Each tiedown platform 408 includes one or more slotted holes 410 through which cable ties (e.g., zip ties, twist ties, etc.) may be laced allowing the optical fibers to be firmly attached to base 404. A proximate end 114A of fiber optic splice tray 114 includes an axle 412 allowing tray 114 to be removably attached to an attachment point such as riser 140 (see FIG. 25). More specifically, axle 412 extending from proximate end 114A of tray 114 slides into one of the notches 142 and then rests in groove 143 in riser 140. The bottom edge portion 147 of tray 114 rests on ledge 145 provided below notch 142 of riser 140, maintaining tray 114 in the horizontal position. Axle 412 is capable of rotating within groove 143 of riser 140k, such that trays 114 can be flipped upward pivoting on axle 412 while still being attached to riser 140 so that any tray in the stack of trays being held by riser 140 can be easily accessed without having to remove any of the trays from the riser 140.

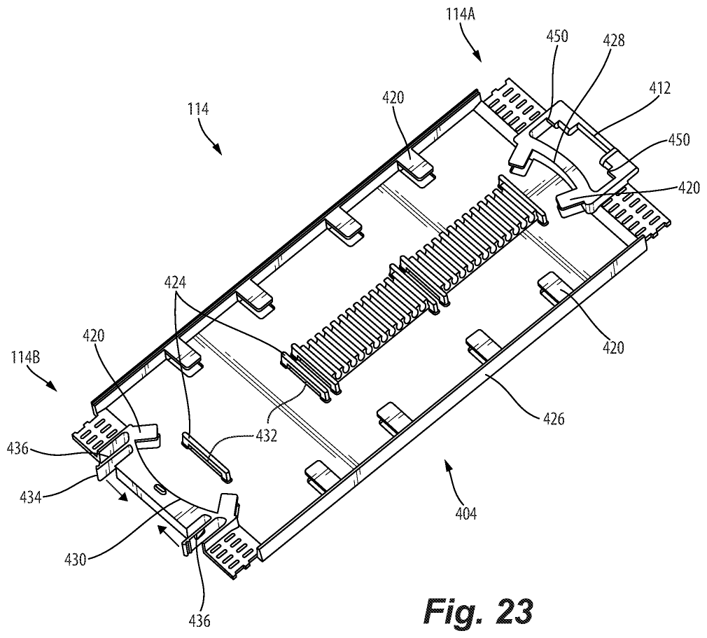

As depicted in FIGS. 23, base 404 includes relatively straight parallel longitudinal walls 426 each including one or more fiber routing tabs 420 extending inwardly from the top thereof. Proximate end 114A of base 404 includes an arcuate wall 428 which also includes one or more inwardly extending fiber routing tabs 420. Distal end 114B of fiber optic splice tray 114 also includes an arcuate wall 430 having one or more inwardly extending fiber routing tabs 420. The diameters of the arcuate walls 428, 430 are greater than a minimum diameter recommended for bending the optical fibers to be held in tray 114. The fiber routing tabs 420 and arcuate walls 428, 430 allow optical fiber slack to be neatly and safely retained within the splice tray 114. One or more splice organizers 422 may be permanently or removably connected to base 404. According to the present illustrative embodiment, removable splice organizers 422 are removably held between splice organizer uprights 424. Each splice organizer upright 424 includes a notched lower portion 432 which receives a corresponding tab (not shown) extending from the end portions of splice organizer 422 holding the splice organizer 422 in place. Since the splice organizers 422 are removable, various types, sizes and configurations of splice organizers may be used as desired. Arms 434 extend outward from the distal end 114B of tray 114 and include notches for engaging corresponding hooks in cover 402.

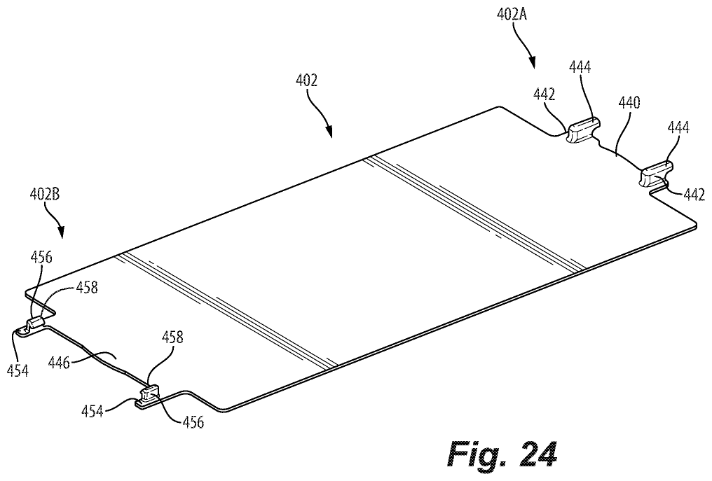

The underside of cover 402 (e.g., the side which faces the inside of tray 114) is depicted in FIG. 24. A distal end of cover 402B of cover 402 includes an extension portion 446 having arms 454 extending therefrom. Posts 456 extend from arms 454 and have latch hook ends 458 protruding therefrom. Proximate end 402A of cover 402 includes an extension portion 440 having uprights 442 extending therefrom, each having a hook-like end 444.

To attach cover 402 to base 404, hook-like ends 444 extending from cover 402 are slipped under rotational points 450 in proximate end 114A of base 404 (FIGS. 23, 23A). Cover 402 is thus pivotally attached to base 404 and is movable between open and closed positions. In the closed position (FIG. 22), the latch hook ends 458 protruding from arms 454 (FIGS. 24, 24A) of cover 402 engage notches 436 in arms 434 of base 404, effectively locking the cover in the closed position. To open cover 402, arms 434 can be squeezed toward each other as shown by the arrows in FIG. 23, disengaging latch hook ends 459 from notches 436 and allowing the cover 402 to be lifted from base 404.

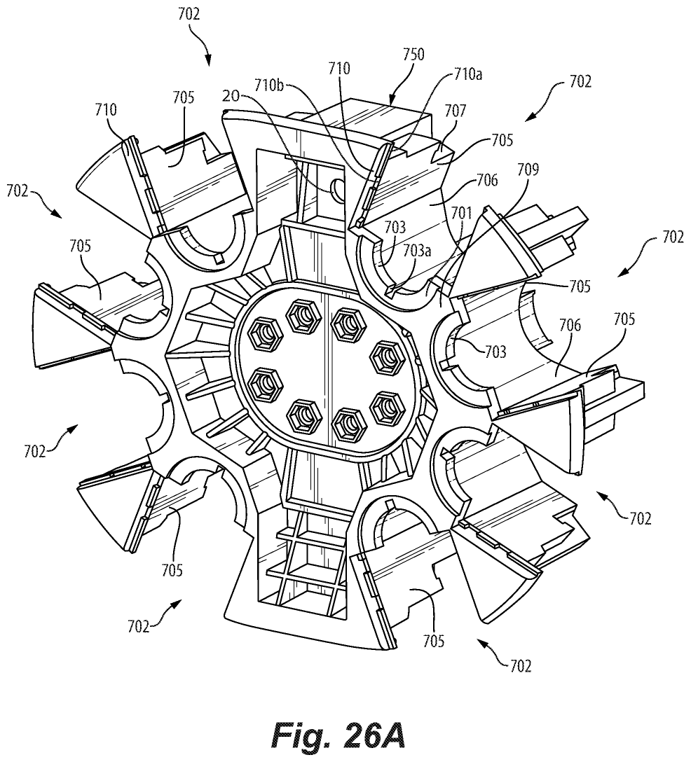

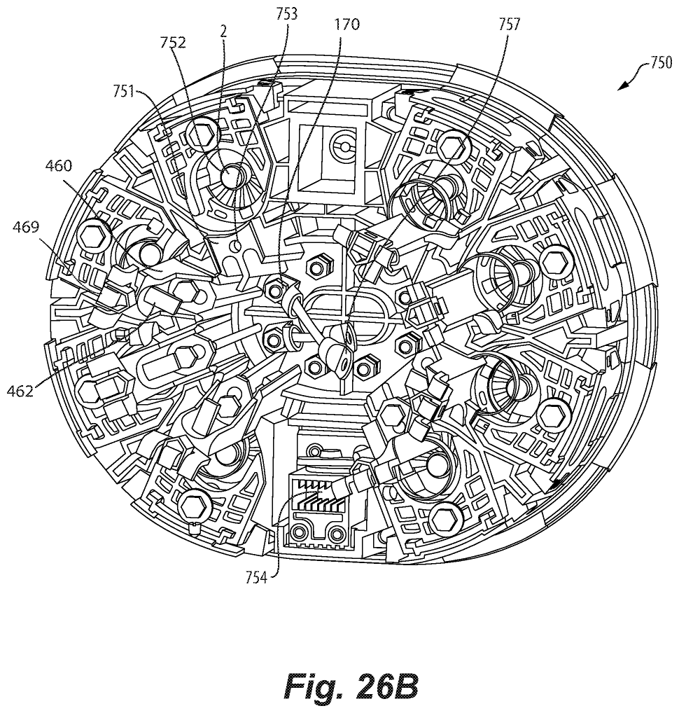

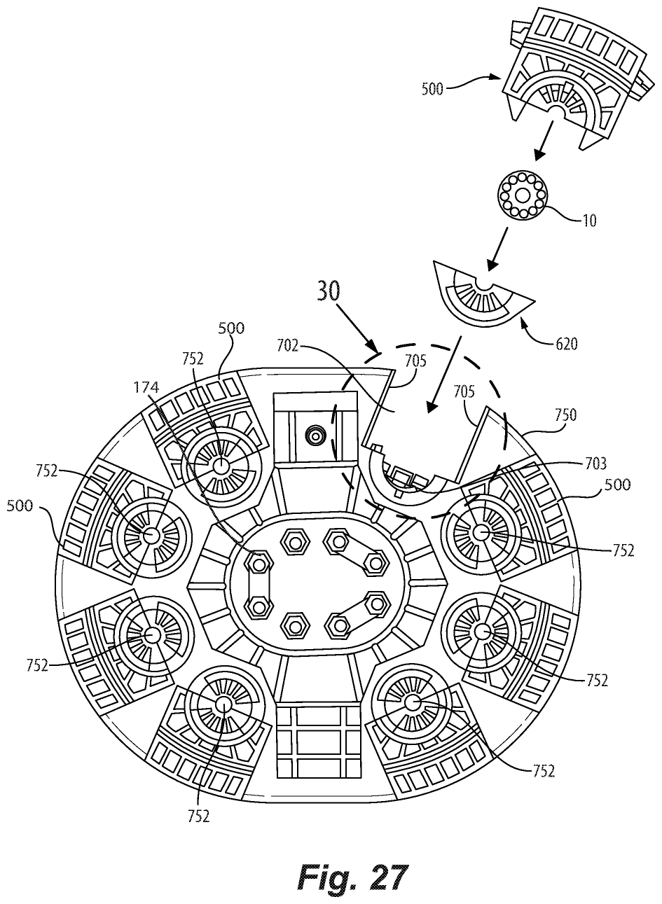

An end plate assembly according to another illustrative embodiment of the present disclosure is shown in FIGS. 26A, 26B and 27 and may be referred to as end plate 750. End plate 750 is similar to end plate assembly 112 described above in certain aspects. For brevity reasons, similar aspects of end plate 750 will not be described again in detail. End plate 750 is generally oblong in shape but may have a different shape such as, for example, oval, elliptical or the like. When assembled, end plate 750 has a plurality of cable receiving ports 752 each capable of receiving a main fiber optic cable. In this illustrative embodiment, eight (8) such cable receiving ports 752 are provided so that up to eight (8) main fiber optic cables can be received in the splice closure assembly. If a particular cable receiving port 752 is not being utilized to receive a fiber optic cable, a plug 2 may be inserted into the cable receiving port. Generally, the plug 2 may be a solid or hollow section of material having a diameter similar to the diameter of cable the cable receiving port is dimensioned to receive. Of course, the shape and dimensions of end plate 750 can be modified and designed to provide more or fewer cable receiving ports 752 as desired. Each cable receiving port 752 is formed by a removable outer receiving port assembly cartridge 500 and an inner gel pad assembly or cartridge 620 which sealingly engages and mates with integral inner receiving port assembly 702. Each cable receiving port 752 is capable of receiving and holding a main fiber optic cable 10 and providing a watertight and airtight seal around the fiber optic cable 10.

End plate 750 includes a front wall 709 having substantially rectangular openings and lower walls 701 having semi-circular opening surfaces 703 forming portions of each integral inner receiving port assembly 702. Each integral inner receiving port assembly 702 also includes inner side walls 705 and lower semi-circular bottom 706 which extend from front wall 709 as shown. The side edge portions 710 of front wall 709 include recessed edge portions 710a and notched keyways 710b. As will be described below, the side edge portions 710 of front wall 709 and inner side walls 705 are positioned and dimensioned to sealingly engage corresponding portions of the removable outer receiving port assembly cartridge 500. The lower semi-circular bottom 706 is recessed from the lower semi-circular opening surface 703 in lower wall 701 and is dimensioned to sealingly engage corresponding portions of the inner gel pad assembly or cartridge 620. The semi-circular opening surface 703 may have a diameter generally the same or larger than a diameter of the fiber optic cable to be received in the cable receiving port 752. The rear portion of end plate 750 includes a bracket 754 similar to bracket 158 described above but instead of being located in the center portion of the end plate 750 is located along a lower edge portion of end plate 750. The lower plate 111 of tray holding assembly 110 may then extend from and be supported by end plate assembly 112 via a generally straight arm member instead of the inverted generally “S-shaped” arm member 128 described above. A hole 20 may be provided in end plate 750 for receiving an air valve (not shown) allowing the enclosure 102 to be pressurized with air and flash tested after the enclosure has been sealed.

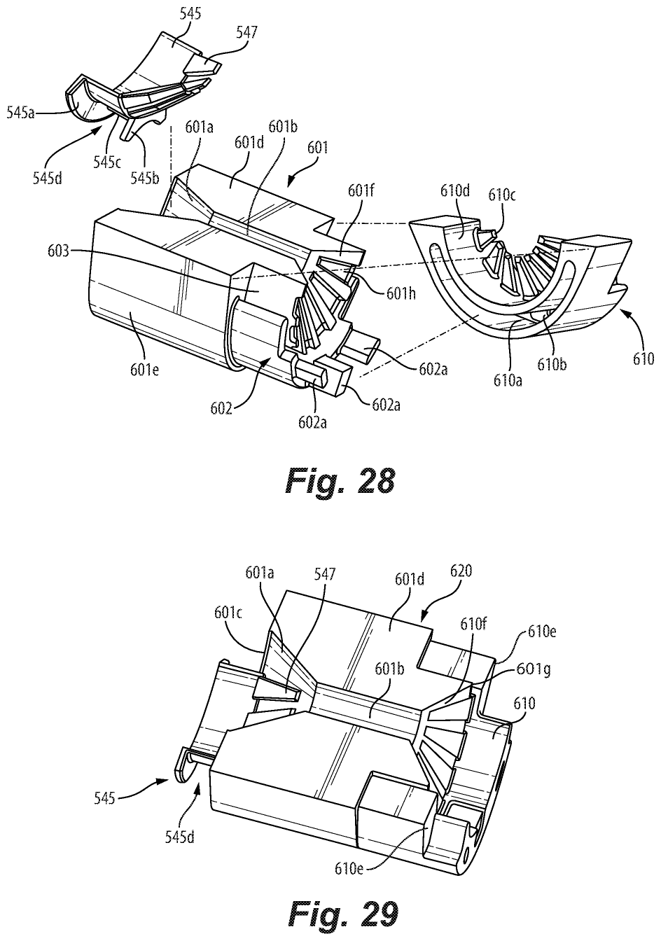

An inner gel pad assembly or cartridge 620 according to an illustrative embodiment of the present disclosure is depicted in FIGS. 28 and 29. Inner gel pad assembly 620 includes a gel pad member 601, inner support member 610 and outer support member 545. Gel pad member 601 includes a flat upper surface 601d having an elongated semi-circular groove 601b and semi-circular tapered portions 601a and 601f. The semi-circular tapered portion 601a tapers from its outside semi-circular leading edge 601c to elongated semi-circular groove 601b. The semi-circular tapered portion 601f tapers from its leading edge 601g to elongated semi-circular groove 601b. Gel pad member 601 has an elongated semi-circular lower surface 601e dimensioned to snugly fit within the semi-circular bottom 706 of integral inner receiving portion assembly 702. Gel pad member 601 also includes a semi-circular portion 602 which is recessed from the elongated semi-circular lower surface 601e and a semi-circular portion 603 which is recessed from the semi-circular portion 602. One or more retention legs 602a extend from semi-circular portion 602. Inner support member 610 includes a semi-circular groove 610a dimensioned and positioned to receive semi-circular portion 602 of gel pad member 601. One or more openings or orifices 610b extend through inner support member 610 and are dimensioned and positioned to receive the one or more retention legs 602a of gel pad member 601, thus securing the inner support member 610 to gel pad member 601. Inner support member 610 has an upper semi-circular surface 610d positioned and dimensioned to receive semi-circular portion 603 of gel pad member 601. An outer edge of upper semi-circular surface 610d includes one or more teeth 610c. Semi-circular tapered portion 601f of gel pad member 601 may include recesses 601h positioned and dimensioned to receive the teeth 610c extending from inner support member 610. Outer support member 545 includes an outside lip 545a and inner lip 545b forming a gap 545d therebetween dimensioned to fit snugly over semi-circular opening surface 703 of integral inner receiving port assembly 702. A key 545c spans the gap 545d and is positioned and dimensioned to snugly fit within notch 703a formed in the semi-circular opening surface 703. Semi-circular tapered portion 601a may include recesses similar to recesses 601h for receiving teeth 547 extending from outer support member 545. As shown in FIG. 29, the outside surfaces of gel pad member 601 sit proud of the outside surfaces of support member 610.

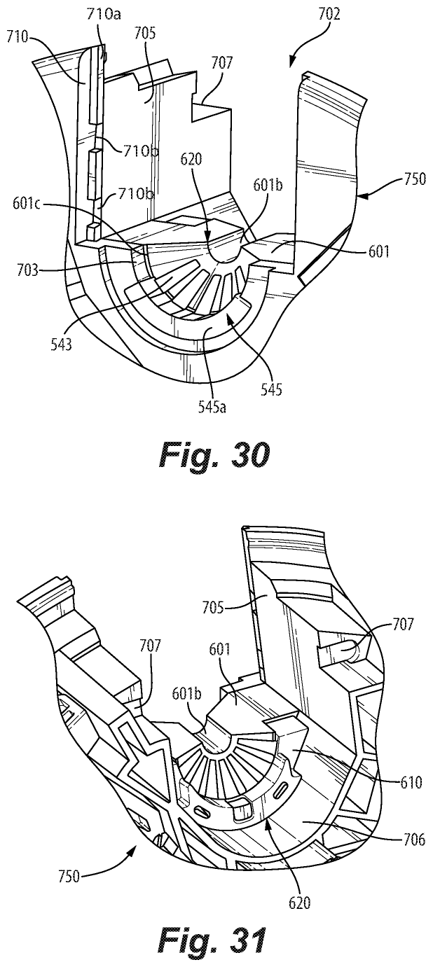

According to the present illustrative embodiment as depicted in FIGS. 30 and 31, the inner gel pad assembly or cartridge 620 rests on semi-circular bottom 706 of integral inner receiving portion assembly 702. The semi-circular opening surface 703 of integral inner receiving port assembly 702 is dimensioned to correspond to the outside semi-circular edge 601c of gel pad member 601. In particular, outside semi-circular edge 601c of gel pad member 601 sits proud of semi-circular opening surface 703 as shown. Outer support member 545 is positioned along the semi-circular opening surface 703 of integral inner receiving port assembly 702 such that teeth 547 abut the semi-circular tapered portion 601a of gel pad member 601. Locking notches 707 are provided alongside wall portions of the inner receiving port assembly 702 and are positioned and dimensioned for receiving latch hooks provided on the removable outer receiving port assembly cartridge 500 as will be described later below.

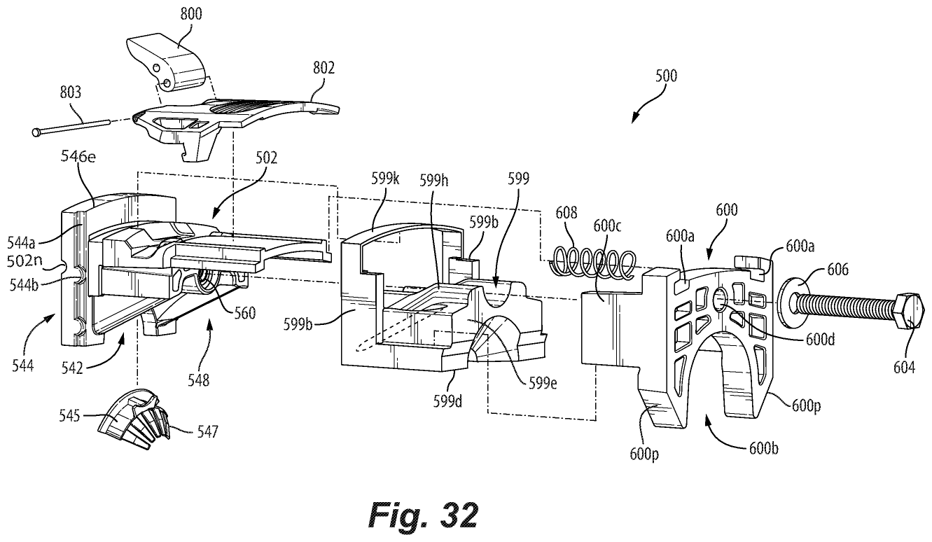

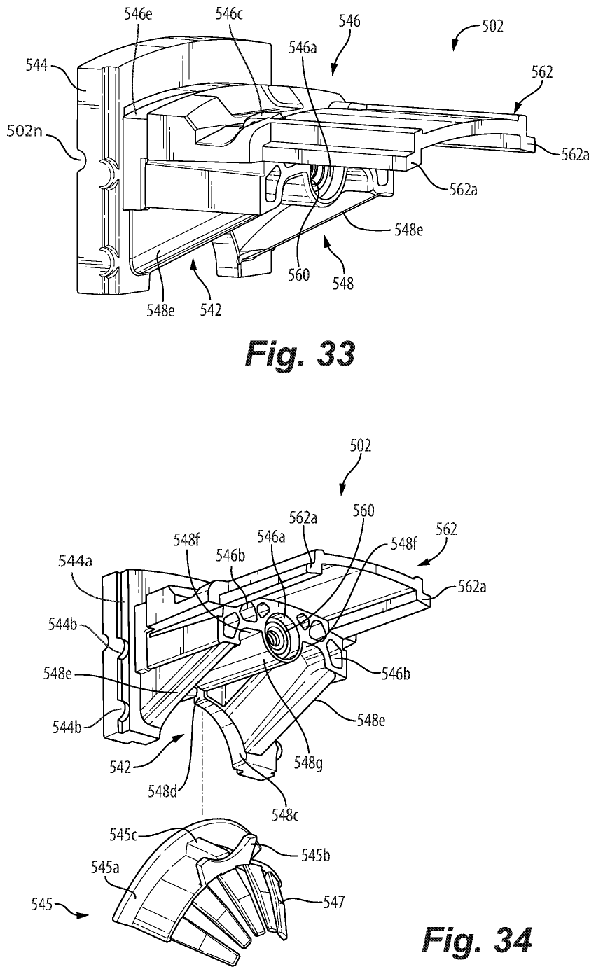

A removable outer receiving port assembly or cartridge according to an illustrative embodiment of the present disclosure is shown in FIGS. 32-38 and may be referred to as assembly or cartridge 500. Cartridge 500 includes a main body 502, gel pad member 599 and compression member 600. Main body 502 has a front wall 544 dimensioned to fit within the rectangular opening in the front wall 709 of integral inner receiving port assembly opening 702 (FIG. 27). In particular, front wall 544 is substantially rectangular and has recessed side edge portions 544a which include one or more key members 544b positioned and dimensioned to engage with the side edge portions 710 of front wall 709. For example, recessed edge portions 544a and key members 544b mate with the edge portions 710a and keyways 710b of front wall 709 of end plate 750 forming an airtight and watertight seal. A semi-circular opening 542 is provided in the front wall 544 of main body 502. The semi-circular opening 542 may have a diameter the same or larger than a diameter of the main fiber optic cable to be received in the cable receiving port. The front walls 544 of the main bodies 502 may include a circular notch 502n dimensioned to receive a gasket 106 allowing a sealing collar such as one of the sealing collars 108 and 208 described herein to provide a watertight and airtight seal to enclosure 102.

A support platform 546 extends from a rear surface of front wall 544. Support platform 546 supports components forming cartridge 500 including, for example, gel pad member 599 and compression member 600. Support platform 546 has a lower mating surface 548 which abuts and mates with an upper surface 599h of gel pad member 599. Lower mating surface 548 includes diagonal side arms 548e, recesses 548f and semi-circular projection 548g. A longitudinal hole or bore 546a extends at least partially though semi-circular projection 548g in the support platform 546. A threaded insert 560 is moulded into or otherwise secured within longitudinal bore 546a. One or more longitudinal holes or bores 546b may also extend at least partially through the components described herein including, for example, the support platform 546 saving material costs and weight. A slide extension 562 extends from support platform 546 and is dimensioned to slidably receive compression member 600. For example, slide extension 562 includes side rails 562a.

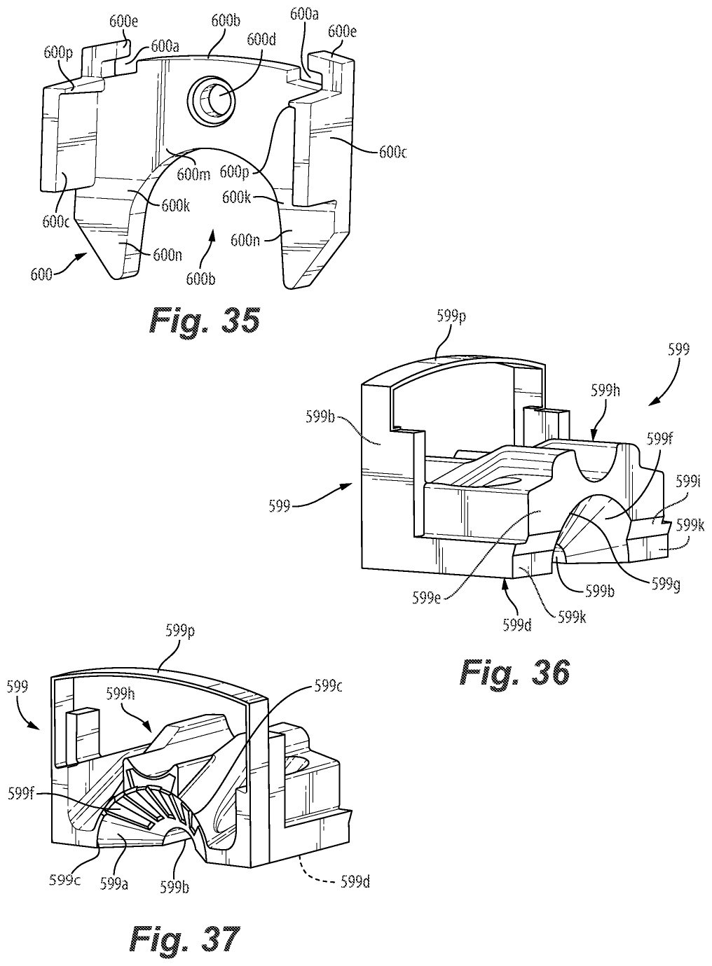

Compression member 600 includes upper C-shaped arms 600e and upper edge 600b forming slots 600a (FIG. 35) which are dimensioned and positioned to receive the side rails 562a, allowing compression member 600 to slide longitudinally along side rails 562a of extension 562. An outer support member 545 similar to that described above with respect to FIG. 28 is positioned along the semi-circular opening 542 provided in the front wall 544 of main body 502 such that teeth 547 abut the semi-circular tapered portion 599a of gel pad member 599. The semi-circular tapered portion 599a of gel pad member 599 may include notches 599f for receiving the teeth 547. Compression member 600 includes an arched opening 600b and side walls 600c. A hole or bore 600d extends through compression member 600 as shown. A bolt 604 extends through washer 606, through hole 600d in compression member 600, through spring 608 and is screwed into threaded insert 560 secured within longitudinal bore 546h in main body 502. The head of bolt 604 may be hexagonal as shown or may be in the shape of a wing nut, allowing the bolt 604 to be tightened by hand so that tools are not required for switching out cartridges described herein with respect to embodiments of the present dislosure.

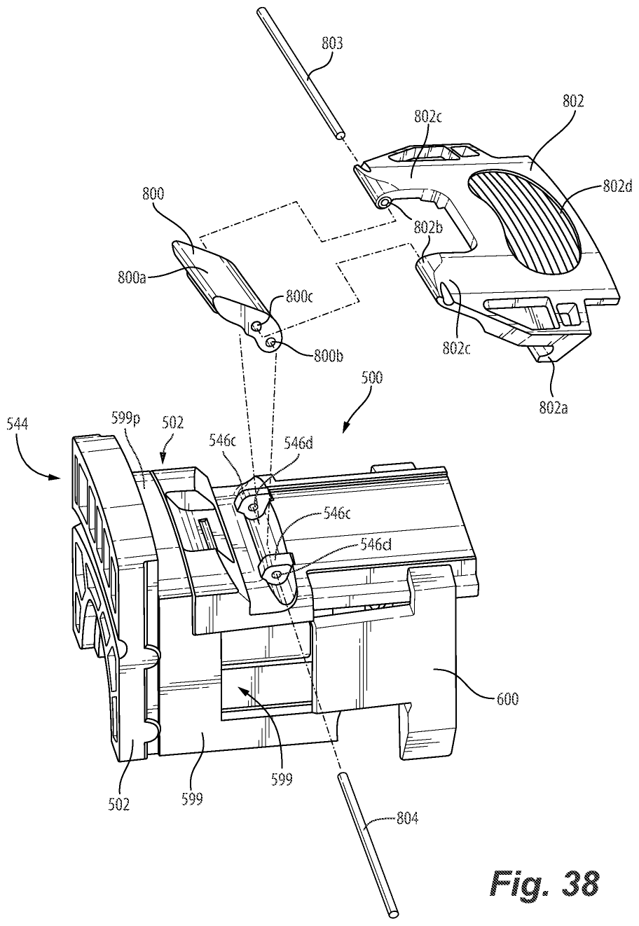

Gel pad member 599 includes an upper mating surface 599h which abuts and mates with the lower mating surface 548 of support platform 546. Gel pad member 599 includes a rear surface which abuts and mates with an inner surface of compression member 600. For example, the rear surface 599e of gel pad member 599 includes step down or angled surfaces 599i which extend to lower surfaces 599k. The inner surface 600m of compression member 600 includes step up or angled surfaces 600k which abut step down or angled surfaces 599i of gel pad member 599. Step up or angled surfaces 600k extend to lower surfaces 600n of lower arms 600p which abut lower surfaces 599k of gel pad member 599. Gel pad member 599 also includes partial side walls 599b and strap member 599p which extends between partial side walls 599b and which wraps around and rests in recessed portion 546e of support platform 546 thus securing the gel pad member 599 to main body 502 (e.g., see FIG. 38). The lower surface 599d of gel pad member 599 is similar to the upper surface 601d of gel pad member 601. For example, the lower surface 599d is substantially flat and includes a longitudinal semi-circular portion 599b and semi-circular tapered portions 599a and 599f similar to longitudinal semi-circular portion 601b and semi-circular tapered portions 601a and 601f of gel pad member 601. The semi-circular tapered portion 599a tapers from its outside semi-circular leading edge 599c to elongated semi-circular groove 599b and may include notches 599n for receiving teeth 547 of outer support member 545. The semi-circular tapered portion 599f tapers from its leading edge 599g to elongated semi-circular groove 599b. When the gel pad members 599 and 601 are mated together when the cartridge 500 is inserted into the integral inner receiving port assembly opening 702, the semi-circular portions 599b and 601b form the circular opening or port 752 (see FIG. 27) dimensioned to receive a main fiber optic cable 10. The semi-circular tapered portions 601a and 599a and 601f and 599f form conically shaped openings to the circular opening or port 752.

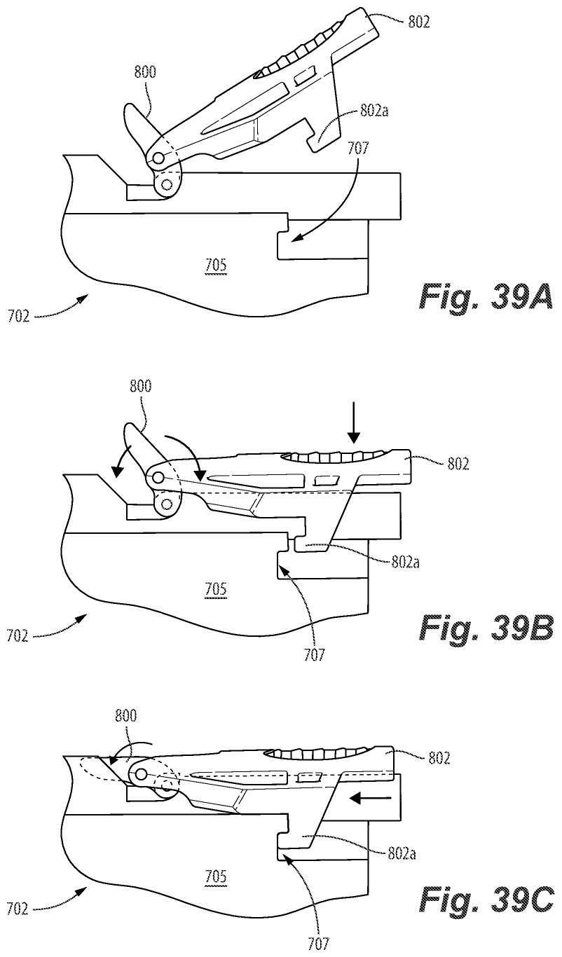

A locking mechanism for locking the cartridge 500 to the integral inner receiving port assembly opening is shown in FIGS. 38 and 39A-39C and includes locking arm member 800 and latch arm member 802. Latch arm member 802 includes a main body 802d having hooks or latches 802a extending therefrom on either side of main body 802d (only one shown). Main body 802d also includes two longitudinal wings 802c extending from main body 802d. The gap between and the length of the two longitudinal wings 802c are dimensioned to receive locking arm member 800. Orifices 802b extend through the distal end portions of the two longitudinal wings 802c for receiving a pin 803 which also extends through orifice 800c in locking arm member 800 such that latch arm member 802 is pivotally attached to locking arm member 800. Locking arm member 800 also includes an orifice 800b extending therethrough. The upper portion of support platform 546 of main body 502 includes a pair of stanchions 546c including holes 546d extending therethrough. A pin 804 extends through the holes 546d in stanchions 546c in support platform 546 and through hole 800b extending through locking arm member 800 such that locking arm member 800 is pivotally attached to support platform 546.

As shown in FIG. 39A, after the cartridge 500 is positioned within the integral inner receiving port assembly opening 702, locking arm member 800 is pivoted up in the clock-wise direction which allows latch member 802 to extend outward (rightward as depicted in FIG. 39A). Latch arm member 802 can then be pressed down so that hooks 802a can engage the locking notches 707 provided in the inner side walls 705 of the integral inner receiving port assembly opening 702. (e.g., see FIG. 26A and FIG. 39B). Locking arm member 800 is then pivoted downward in the counter clock-wise direction which draws latch member 802 inward (leftward as depicted in FIG. 39C) tightening hooks 802a in the locking notches 707. Because of the arrangement of the attachment points of the latch member 802 and the locking arm member 800 and the support platform 546, locking arm member 800 will snap into and remain in the closed and locked position depicted in FIG. 39C. Locking arm member 800 can be lifted in the clockwise direction, reversing the above-described process to release the cartridge 500.

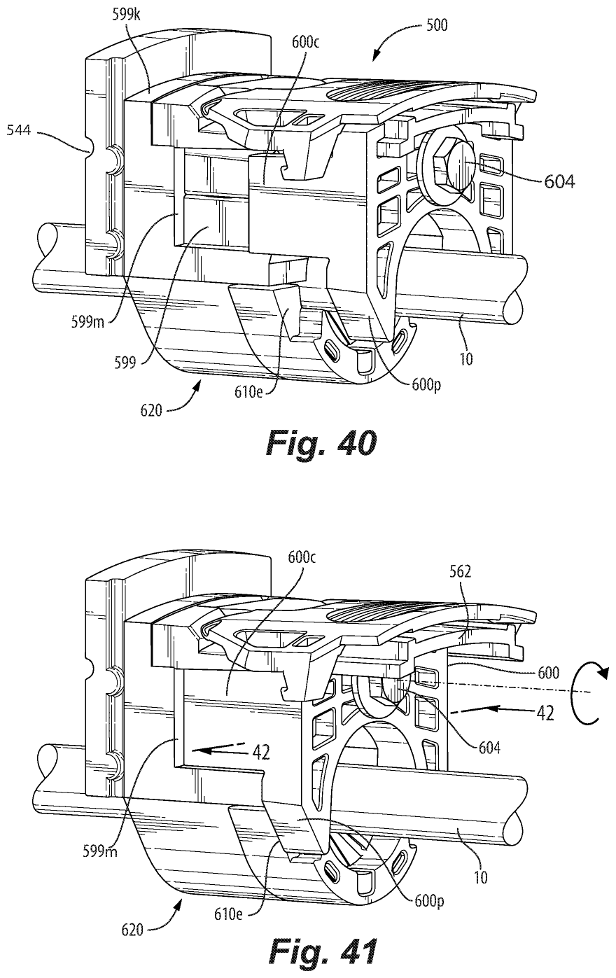

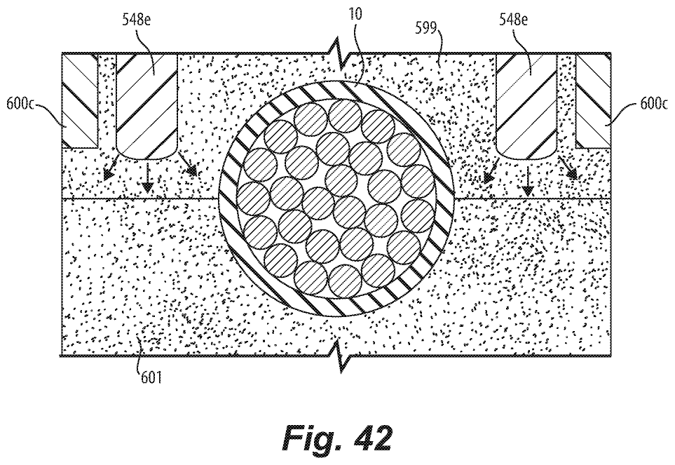

The closed and locked cartridge 500 and lower gel pad assembly 620 are depicted in FIGS. 40 and 41 outside of the integral inner receiving port assembly opening 702 for purposes of illustration. Once the cartridge 500 is in the integral inner receiving port assembly opening 702 and in the closed and locked position depicted in FIGS. 40 and 41, bolt 604 can be tightened in the clock-wise direction drawing compression member 600 inward toward front wall 544 until side walls 600c make contact with the edge portions 599m of gel pad 599. This draws compression member 600 inward toward front wall 544 contacting and compressing gel pad 599 between the front wall 544 and compression member 600. The lower leg 600p of compression member 600 also contacts upper wall 610e of inner support member 610 compressing lower gel pad member 601 between the inner support member 610 and the inner surface of lower wall 701 of the end plate assembly 750. As depicted in FIG. 42, during compression, the diagonal side arms 548e extending from the lower mating surface 548 of support platform 546 urge the gel pad surfaces inward and downward forming a tight waterproof and airtight seal around cable 10.

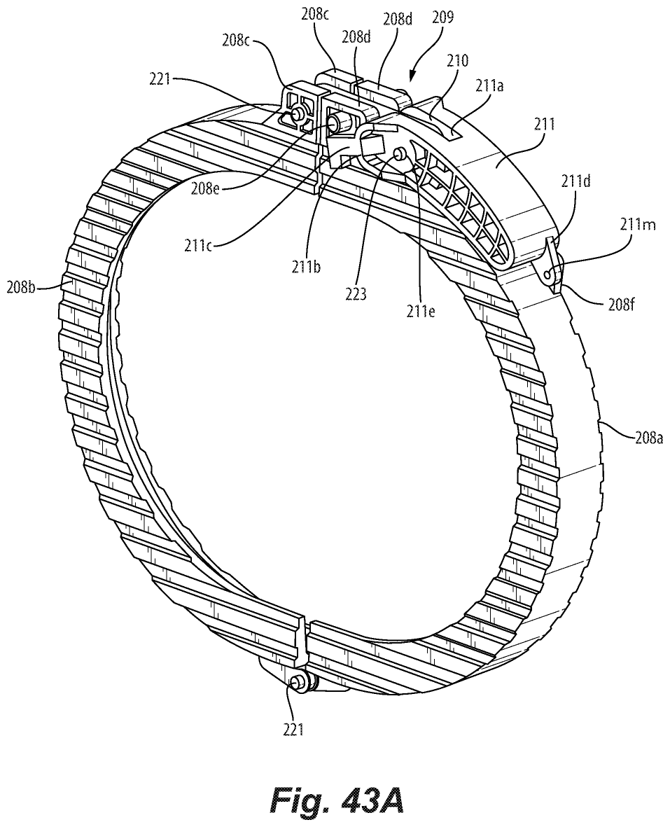

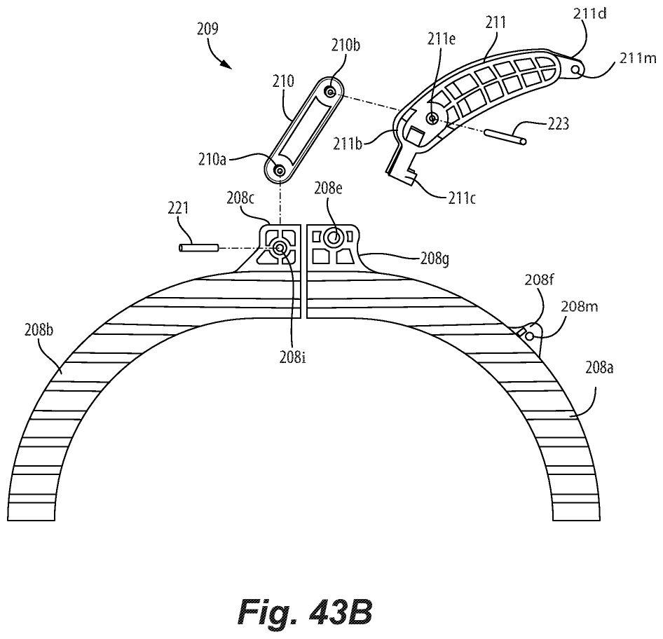

A sealing collar according to another illustrative embodiment of the present disclosure is shown in FIGS. 43A and 43B and is referred to sealing collar 208. Sealing collar 208 is utilized in a similar manner to sealing collar 108 described above to seal the second end of the fiber optic enclosure 102 using end plate assembly 112 or 750 and one or more gaskets 106. Sealing collar 208 includes a generally U-shaped first portion 208a and a generally U-shaped second portion 208b joined at their distal ends by hinge member 221. First and second portions 208A and 208B are generally U-shaped in cross-section. A clamping mechanism 209 is provided for removably joining the first portion 208A and the second portion 208B at their proximal ends. The proximal end of second portion 208B includes flanges 208c having holes 208i which extend therethrough. A pin 221 extends through holes 208i and a hole 210a in a proximal end of arm 210, allowing arm 210 to pivot thereon. Locking cam arm member 211 includes a slot 211a, for receiving the distal end of arm 210. A pin 223 extends through holes 211e in locking cam arm member 211 and hole 210b in arm 210, allowing locking cam arm member 211 and arm 210 to pivot with respect to each other. Locking cam arm member 211 includes cam surfaces 211b which engage cam surfaces 208g in flanges 208d provided on the proximal end of first portion 208A of sealing collar 208 when locking cam arm member 211 is in the locking position. When placed in the locking position with cam surfaces 211b engaging cam surfaces 208g, locking cam arm member 211 can be rotated clockwise. Because of the offset pivot point at holes 211e with respect to cam surfaces 211b, this will draw the proximal ends of the first portion 208A and the second portion of sealing collar 208 together to the locked position indicated in FIG. 43A creating an airtight and watertight seal around the second end 118 of enclosure 102 and end plate 750. Locking cam arm member 22 includes stop arms 211c which engage stops 208e extending from flanges 208d for stopping over rotation of cam arm member 211 and keeping the cam surfaces engaged when in the locked position. A locking pin (not shown) may be inserted through hole 211m in flange 211d extending from locking cam arm member 211 and a corresponding hole 208m in flange 208f extending from second portion 208b of sealing collar 208.

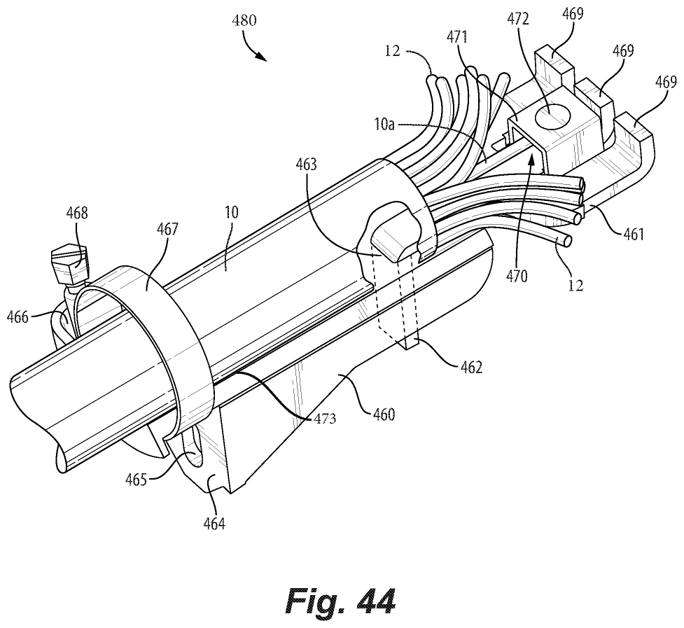

A strength member according to another illustrative embodiment of the present disclosure is shown in FIG. 44 and is referred to as strength member 480. Strength member 480 includes strength member body 460 and strength member tie 461. Strength member body 460 includes an upper surface 473 upon which the jacketed portion of main fiber optic cable 10 rests. The jacketed portion of main fiber optic cable 10 may be secured to surface 473 utilizing a pipe clamp 467. Strength member body 460 has a lower wall 464 which includes an oblong hole 465 extending therethrough. Lower wall 464 is dimensioned to be received in corresponding mating surface 751 in the rear of end plate 750 (see FIG. 26B) and secured using a bolt (not shown) extending through the hole 465 in lower wall 464 and received in threaded bore 753. Oblong hole 465 allows the strength member 480 to be moved up and down to adjust the height of the upper surface 473 of the strength member body 460 so that it aligns with the cable 10 coming through cable receiving port 752. The distal end of strength member tie 461 includes an L-shaped leg 462 which is press fit through a slot 463 provided in strength member body 460. After cable 10 is placed on the upper surface 473, pipe clamp 467 is tightened using a screw-drive mechanism driven by screw 468 which can be used to also loosen clamp 467. Strength member body 460 includes a recessed area 466 for holding the screw drive mechanism portion of pipe clamp 467. The strength member component 10a of main fiber optic cable 10 extends into opening 470 of clamp 471 and is secured to strength member tie 461 utilizing clamp 471 and set screw 472. The proximal end of strength member tie 461 includes one or more and in this embodiment three fork like projections 469 which may be used to secure cables having different types of strength member components. For example, some fiber optic cables include a metal layer under a polymer layer to provide protection to the delicate optical fibers from damage caused by rodents or other factors. This metal layer may be readily attached to the fork like projections 469 of strength member tie 461 in any suitable manner. The three fork-like projections 469 allow various other types of strength members to be attached thereto including strength members that are central and other types that may run along one or more sides of the cable 10. The individual optical fibers or cables 12 extending from main fiber optic cable 10 are routed within enclosure 102 to splice trays 114 or 214.

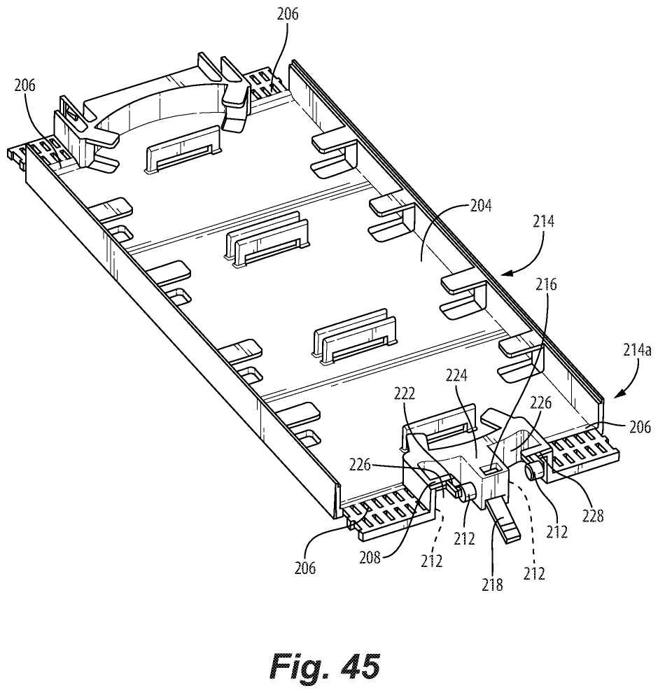

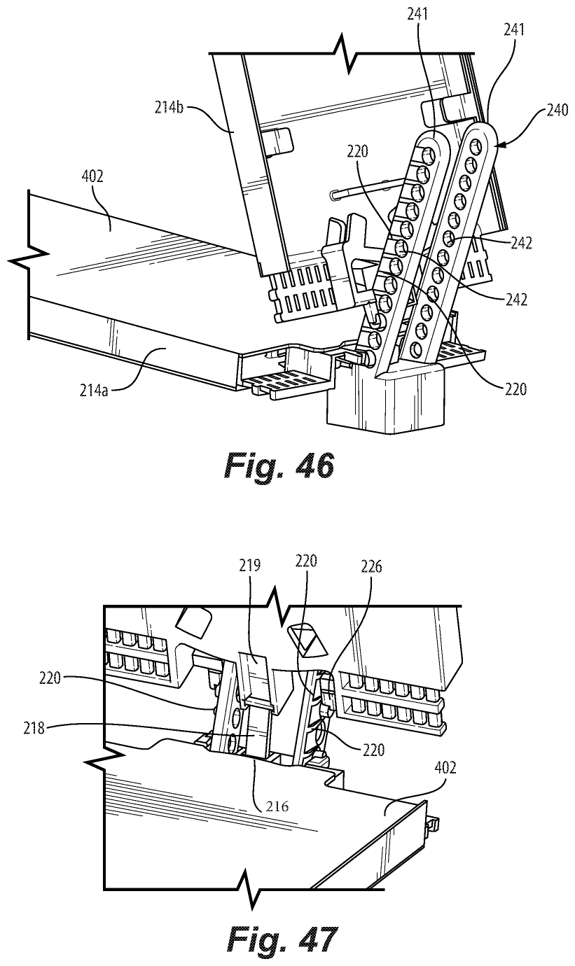

A fiber optic splice tray 114 according to another illustrative embodiment of the present disclosure is shown in FIGS. 45-47 and may be referred to simply as tray 214. Tray 214 is similar in certain aspects to splice tray 114 described above. Accordingly, features of tray 214 common to tray 114 will not be described again in detail. Tray 214 includes a base 204. A cover similar to cover 402 described above with respect to FIG. 24 may be used to cover tray 214. One or more optical fiber openings 206 may be provided allowing optical fibers or cables 12 to be routed in and out of the fiber optic splice tray 214. According to the present illustrative embodiment, four optical fiber openings 206 are provided, one at each corner of the tray 214. A proximal end 214a of fiber optic splice tray 214 includes an extension block 224 and legs 228 each having pins 212 extending inward toward openings 226. Pins 212 allow tray 214 to be removably attached to an attachment point such as riser 240. More specifically, pins 212 slide into the notches 242 in the parallel riser arms 241, allowing the tray 214 to pivot or rotate upward and downward with respect to riser 240. Trays 214 are normally positioned horizontally as depicted by tray 214A in FIG. 46. Trays 214 and riser 240 include structure for holding a tray in an upward position (see tray 214B depicted in FIG. 46) allowing work to be performed on trays lower in the stack of trays. For example, detents 222 extend inward toward openings 226 in tray 214 and engage detent projections 220 on the sides of riser arms 241 when tray 214 is rotated upward (e.g., see FIG. 47). To ensure the tray remains in the upward position, an arm 218 which is pivotally attached to a recessed arm storage area 219 on the bottom surface of tray 214, may be extended so that it rests in a notch 216 provided in the upper surface of extension block 224 in a lower tray in the stack. In this way, trays 214 can be flipped upward while still being attached to riser 240 so that any tray in the stack of trays being held by riser 240 can be easily accessed and worked on without having to remove any of the trays from the riser 240. Of course, trays 214 may be readily removed from riser 240 by disengaging pins 212 from the notches 242 in the parallel riser arms 241.

As described herein, the components forming the cable receiving ports (e.g., ports 152, 752) are provided as replaceable components or cartridges. Accordingly, the enclosure 102 can be readily modified to receive fiber optic cables of various diameters simply by substituting these components with components dimensioned to receive fiber optic cables of varying diameters as desired.

In a first embodiment described above with respect to FIG. 8, the distal end 172 of threaded ground rod assembly 170 extends through an orifice 252 which extends through end plate 250. The proximate end 176 of threaded ground rod assembly 170 extends inward from orifice and the ground rod assembly 170 is tied directly to the metallic strength member 132. In contrast, in the embodiment depicted in FIG. 26B, the strength member body 460 is non-metallic and is attached directly to the non-metallic mating surface 751 in the rear surface of non-metallic end plate 750. If desired, one end of a ground braid 757 may be attached to the ground rod assembly 170 passing through the end plate 250 and the other end attached to the L-shaped leg 462 of the electrically conductive strength member tie 461. This allows one or more of the electrically conductive strength tie members 461 to be tied to ground as warranted or desired by the end user. As described above, the distal ends 172 of one or more of the ground rods 170 may be interconnected. For example, as shown in FIG. 9, one or more electrically conductive plates 257 may be provided for electrically interconnecting two or more and in this exemplary embodiment, each of the eight (8) ground rod assemblies 170 passing through end plate 250. The ground rods 170 may thus be tied to ground/earth individually or in a batch.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

Certain terminology may be used in the present disclosure for ease of description and understanding. Examples include the following terminology or variations thereof: up, upward, inner, outer, down, downward, upper, lower, etc. These terms refer to directions in the drawings to which reference is being made and not necessarily to any actual configuration of the structure or structures in use and, as such, are not necessarily meant to be limiting.

The gel pad or gel pad members described herein are generally formed from a thermal plastic elastomer or TPE material. The TPE material forming the gel pad or gel pad members generally has a specific gravity of roughly 0.87, a viscosity@11170/sec of roughly 3.4 Pa·s, a tensile elongation@break of roughly 691.9%, a tensile strength@break of roughly 45.9 psi and a hardness of roughly 40. The gel pad or gel pad members may be formed utilizing any suitable manufacturing method including, for example, injection molding.

Elements forming portions of the splice closure assembly described herein may be formed from any suitable type of material. For example, those elements requiring electrical continuity (e.g., ground rod assembly, strength member 132, strength member tie 461, etc.) may be formed from any suitable type of electrically conductive material including steel, aluminium, etc. Other elements not requiring electrical continuity may be formed from suitable types of materials including high impact resistant plastics. Polycarbonite or polyvinyl chloride (PVC) may be used as well as polypropolyne alone or in combination with one or more strengthening material(s) such as additive-filled polypropylene. Suitable strengthening materials may include fiberglass, carbon fibers, etc. S-shaped arm 128, lower plate 111, strap members 148, 149 may be formed from, for example, spring steel. To provide protection from the environment, it is preferable any steel elements by stainless steel.

What is claimed is:

1. A fiber optic cable closure assembly comprising:
an enclosure having an open end;
an end plate assembly for sealing the open end, the end plate assembly comprising,
at least one fiber optic cable receiving port comprising:
a first cable receiving port cartridge at least a portion of which is formed integral to the end plate assembly;
a second cable receiving port cartridge movable with respect to the first cable receiving port cartridge between at least first and second positions; and
a latch member operably associated with the second cable receiving port cartridge for selectively securing the first cable receiving port cartridge to the second cable receiving port cartridge,
wherein in the first position, the first and second cable receiving port cartridges allow a cable to be positioned between the first and second cable receiving port cartridges and wherein in the second position, the first and second cable receiving port cartridges form a sealing closure around the cable positioned between the first cable receiving port cartridge and the second cable receiving port cartridge.

2. The fiber optic cable closure assembly according to claim 1, wherein a plurality of fiber optic cable receiving ports are provided.

3. The fiber optic cable closure assembly according to claim 1, wherein the sealing closure around the cable is at least one of airtight and watertight.

4. The fiber optic cable closure assembly according to claim 1, wherein the first cable receiving port cartridge and the second cable receiving port cartridge comprise gel pads.

5. The fiber optic cable closure assembly according to claim 4, wherein the gel pads form the sealing closure around the cable.

6. The fiber optic cable closure assembly according to claim 1, wherein the latch member secures the second cable receiving port cartridge to the first cable receiving port cartridge when the second cable receiving port cartridge is in the second position.

7. The fiber optic cable closure assembly according to claim 6, wherein the latch member comprises a ratchet mechanism.

8. The fiber optic cable closure assembly according to claim 7, wherein the ratchet mechanism engages a ratchet tooth on the first cable receiving port assembly.

9. The fiber optic cable closure assembly according to claim 1, further comprising a strength member for securing the fiber optic cable within the enclosure.

10. A fiber optic cable closure comprising:
a first cable receiving port cartridge including a first pliable gel pad, at least a portion of the first cable receiving port cartridge being formed integral to the fiber optic cable closure;
a second cable receiving port cartridge including a second pliable gel pad, the second cable receiving port cartridge movable with respect to the first cable receiving port cartridge between at least first and second positions,
wherein in the first position, the first and second cable receiving port cartridges allow a cable to be positioned between the first and second pliable gel pads and wherein in the second position, the first and second pliable gel pads form a sealing closure around the cable.

11. The fiber optic cable closure according to claim 10, further comprising at least one prong extending into each of the first pliable gel pad and the second pliable gel pad.

12. The fiber optic cable closure according to claim 11, wherein a plurality of prongs extend into each of the first pliable gel pad and the second pliable gel pad.

13. The fiber optic cable closure according to claim 12, wherein the plurality of prongs extend at an angle transversing a portion of a longitudinal length of each of the first pliable gel pad and the second pliable gel pad.

14. The fiber optic cable closure according to claim 13, wherein the at least one prong extending into each of the first pliable gel pad and the second pliable gel pad support the cable substantially centered between the first and second pliable gel pads.

15. The fiber optic cable closure according to claim 14, wherein a portion of the first pliable gel pad and the second pliable gel pad is removed or missing.

16. The fiber optic cable closure according to claim 15, wherein the portions of the first pliable gel pad and the second pliable gel pad comprise half conical cartridges.

17. The fiber optic cable closure according to claim 10, further comprising a latch member operably associated with the second cable receiving port cartridge for selectively securing the first cable receiving port cartridge to the second cable receiving port cartridge.

18. The fiber optic cable closure according to claim 17, wherein the latch member secures the second cable receiving port cartridge to the first cable receiving port cartridge when the second cable receiving port cartridge is in the second position.

19. The fiber optic cable closure according to claim 18, wherein the latch member comprises a ratchet mechanism.

20. The fiber optic cable closure according to claim 19, wherein the ratchet mechanism engages a ratchet tooth on the first cable receiving port assembly.
